(19) United States
(12) Patent Application Publication
(10) Pub. No.: US 2022/0258038 A1
(43) Pub. Date: Aug. 18, 2022

(54) BINGO5O CARD GAME

(71) Applicant: ANTHONY O'HAGAN, BROOKSHIRE, TX (US)

(72) Inventor: ANTHONY O'HAGAN, BROOKSHIRE, TX (US)

(21) Appl. No.: 17/669,602

(22) Filed: Feb. 11, 2022

Related U.S. Application Data
(60) Provisional application No. 63/149,126, filed on Feb. 12, 2021.

(51) Int. Cl. A63F 3/06; A63F 1/02; A63F 3/00

(52) U.S. Cl. CPC A63F 3/062; A63F 2001/0466; A63F 3/00643; A63F 1/02

(57) ABSTRACT

A system including a deck of cards that is configured to play a bingo game, in which said deck of cards comprise 50 individual cards including at least 10 cards with letter B's, at least 10 cards with letter I's, at least 10 cards with letter N's, at least 10 cards with letter G's, and at least 10 cards with letter O's. A set of game play instructions include rules for playing the bingo game, wherein winning a hand in said bingo game comprises making at least one of a bingo and five of the same letter from any combination of hold cards and community cards.

### CROSS-REFERENCE TO RELATED APPLICATIONS

The present Utility patent application claims priority benefit of the U.S. provisional application for patent Ser. No. 63/149,126, entitled “BINGO50 CARD GAME”, filed on Feb. 12, 2021, under 35 U.S.C. 119(e). The contents of this related provisional application are incorporated herein by reference for all purposes to the extent that such subject matter is not inconsistent herewith or limiting hereof.

### INCORPORATION BY REFERENCE OF SEQUENCE LISTING PROVIDED AS ATEXT FILE

Not applicable.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection by the author thereof. The copyright owner has no objection to the facsimile reproduction by anyone of the patent document or patent disclosure for the purposes of referencing as patent prior art, as it appears in the Patent and Trademark Office, patent file or records, but otherwise reserves all copyright rights whatsoever.

### BACKGROUND OF THE RELEVANT PRIOR ART

One or more embodiments of the invention generally relate to bingo card game. More particularly, certain embodiments of the invention relate to system and method for playing bingo50 card game.

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon. By way of educational background, another aspect of the prior art generally useful to be aware of is that for a traditional bingo card game play, each player may purchase one or more bingo cards that bear under the columns B-I-N-G-O multiple bingo numbers of a set of a plurality of bingo numbers (e.g., 1-75). The bingo numbers of the set are then sequentially drawn at random (e.g., selected via a random number generator). If a drawn bingo number matches a bingo number on a player's bingo card, that bingo number is marked on the player's bingo card. The draw may continue until the marks on one of the player's bingo cards form a predetermined game-winning pattern or game-ending pattern. At that point, the play of the traditional bingo game ends, and the player whose marked bingo card forms the game-winning pattern is provided an award. Some traditional bingo card games may also include one or more interim winning patterns. If the marks on a player's bingo card form an interim pattern, the player may win an interim award. Unlike a game-winning or ending pattern match, an interim pattern match doesn't end the bingo number draw. Some traditional bingo card games may require an interim pattern to be marked within a particular quantity of bingo number draws (e.g., within the first five to ten bingo number draws). Traditional bingo card systems typically rank interim patterns from highest to lowest priority (e.g., highest to lowest associated interim award). If multiple interim patterns are marked on a single bingo card, the traditional bingo card system usually provides the interim award for the highest priority marked interim pattern and ignores the other (e.g., lower priority) marked interim patterns. Gaming machines may provide players awards in primary games. Gaming machines generally require the player to place a wager to activate the primary game. The award may be based on the player obtaining a game-winning pattern winning symbol or symbol combination and on the amount of the wager. There are numerous variations of the traditional bingo card game. One particular variation is played with electronic/digital bingo card representations rather than the traditionally printed bingo cards. In these electronic/digital bingo card games, each bingo card is represented by a data structure that defines the various card locations and designations associated with the locations. The game may be played through player stations connected via a communications network. A memory in a central computer system or game server in the network may store bingo card representations and communicating bingo card representations to players at the player stations. The player stations may display the bingo cards defined by the card representations and may allow the players to daub or mark designation matches on their cards as the designations associated with the ball draw are announced in the game. An electronic bingo game may be played remotely by each player which may not be possible with traditional paper bingo games. A bingo game may be more exciting if skill is incorporated as opposed to regular bingo which just makes players follow along. A new and improved bingo gaming technology that provides interactive bingo games that enables player input to affect a bingo game outcome may be desirable.

In view of the foregoing, it is clear that these traditional games are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is an illustration of an exemplary BINGO50-STEADY game play in an initial stage, in accordance with an embodiment of the present invention;

FIG. 2 is an illustration of an exemplary BINGO50-STEADY game play in a succeeding stage, in accordance with an embodiment of the present invention;

FIG. 3 is an illustration of an exemplary BINGO50-STEADY game play in a subsequent stage, in accordance with an embodiment of the present invention;

FIG. 4 is an illustration of an exemplary BINGO50-STEADY game play in a subsequent stage, in accordance with an embodiment of the present invention;

FIG. 5 is an illustration of an exemplary fifth step BINGO50-STEADY game play, in accordance with an embodiment of the present invention;

FIG. 6 is an illustration of an exemplary sixth step BINGO50-STEADY game play, in accordance with an embodiment of the present invention;

FIG. 7 is an illustration of an exemplary seventh step BINGO50-STEADY game play in a winner stage, in accordance with an embodiment of the present invention;

FIG. 8 is an illustration of an exemplary alternative seventh step BINGO50-STEADY game play, in accordance with an embodiment of the present invention;

FIG. 9 is an illustration of an exemplary BINGO50-FREEZE game play, in accordance with an embodiment of the present invention;

FIG. 10 is an illustration of an exemplary BINGO50-MAX game play, in accordance with an embodiment of the present invention;

FIG. 11 is an illustration of an exemplary BINGO50 card deck and card features, in accordance with an embodiment of the present invention;

FIG. 12 is an illustration of an exemplary BINGO50 game play jackpot hands, in accordance with an embodiment of the present invention;

FIG. 13 is a block diagram depicting an exemplary client/server system which may be used by an exemplary web-enabled/networked embodiment of the present invention, in accordance with an embodiment of the present invention;

FIG. 14 illustrates a block diagram depicting a client/server communication system, which may be used by an exemplary web-enabled/networked embodiment of the present invention, in accordance with an embodiment of the present invention; and

FIG. 15 illustrates a flowchart depicting a bingo50 card game system, in accordance with an embodiment of the present invention.

Unless otherwise indicated illustrations in the figures are not necessarily drawn to scale.

### DETAILED DESCRIPTION OF SOME EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

All words of approximation as used in the present disclosure and claims should be construed to mean “approximate,” rather than “perfect,” and may accordingly be employed as a meaningful modifier to any other word, specified parameter, quantity, quality, or concept. Words of approximation, include, yet are not limited to terms such as “substantial”, “nearly”, “almost”, “about”, “generally”, “largely”, “essentially”, “closely approximate”, etc.

As will be established in some detail below, it is well settled law, as early as 1939, that words of approximation are not indefinite in the claims even when such limits are not defined or specified in the specification.

For example, see Ex parte Mallory, 52 USPQ 297, 297 (Pat. Off. Bd. App. 1941) where the court said “The examiner has held that most of the claims are inaccurate because apparently the laminar film will not be entirely eliminated. The claims specify that the film is “substantially” eliminated and for the intended purpose, it is believed that the slight portion of the film which may remain is negligible. We are of the view, therefore, that the claims may be regarded as sufficiently accurate.”

Note that claims need only “reasonably apprise those skilled in the art” as to their scope to satisfy the definiteness requirement. See Energy Absorption Sys., Inc. v. Roadway Safety Servs., Inc., Civ. App. 96-1264, slip op. at 10 (Fed. Cir. Jul. 3, 1997) (unpublished) Hybridtech v. Monoclonal Antibodies, Inc., 802 F.2d 1367, 1385, 231 USPQ 81, 94 (Fed. Cir. 1986), cert. denied, 480 U.S. 947 (1987). In addition, the use of modifiers in the claim, like “generally” and “substantial,” does not by itself render the claims indefinite. See Seattle Box Co. v. Industrial Crating & Packing, Inc., 731 F.2d 818, 828-29, 221 USPQ 568, 575-76 (Fed. Cir. 1984).

Moreover, the ordinary and customary meaning of terms like “substantially” includes “reasonably close to: nearly, almost, about”, connoting a term of approximation. See In re Frye, Appeal No. 2009-006013, 94 USPQ2d 1072, 1077, 2010 WL 889747 (B.P.A.I. 2010) Depending on its usage, the word “substantially” can denote either language of approximation or language of magnitude. Deering Precision Instruments, L.L.C. v. Vector Distribution Sys., Inc., 347 F.3d 1314, 1323 (Fed. Cir. 2003) (recognizing the “dual ordinary meaning of th[e] term [”substantially“] as connoting a term of approximation or a term of magnitude”). Here, when referring to the “substantially halfway” limitation, the Specification uses the word “approximately” as a substitute for the word “substantially” (Fact 4). (Fact 4). The ordinary meaning of “substantially halfway” is thus reasonably close to or nearly at the midpoint between the forwardmost point of the upper or outsole and the rearwardmost point of the upper or outsole.

Similarly, the term ‘substantially’ is well recognized in case law to have the dual ordinary meaning of connoting a term of approximation or a term of magnitude. See Dana Corp. v. American Axle & Manufacturing, Inc., Civ. App. 04-1116, 2004 U.S. App. LEXIS 18265, *13-14 (Fed. Cir. Aug. 27, 2004) (unpublished). The term “substantially” is commonly used by claim drafters to indicate approximation. See Cordis Corp. v. Medtronic AVE Inc., 339 F.3d 1352, 1360 (Fed. Cir. 2003) (“The patents do not set out any numerical standard by which to determine whether the thickness of the wall surface is ‘substantially uniform.’ The term ‘substantially,’ as used in this context, denotes approximation. Thus, the walls must be of largely or approximately uniform thickness.”); see also Deering Precision Instruments, LLC v. Vector Distribution Sys., Inc., 347 F.3d 1314, 1322 (Fed. Cir. 2003); Epcon Gas Sys., Inc. v. Bauer Compressors, Inc., 279 F.3d 1022, 1031 (Fed. Cir. 2002). We find that the term “substantially” was used in just such a manner in the claims of the patents-in-suit: “substantially uniform wall thickness” denotes a wall thickness with approximate uniformity.

It should also be noted that such words of approximation as contemplated in the foregoing clearly limits the scope of claims such as saying ‘generally parallel’ such that the adverb ‘generally’ does not broaden the meaning of parallel. Accordingly, it is well settled that such words of approximation as contemplated in the foregoing (e.g., like the phrase ‘generally parallel’) envisions some amount of deviation from perfection (e.g., not exactly parallel), and that such words of approximation as contemplated in the foregoing are descriptive terms commonly used in patent claims to avoid a strict numerical boundary to the specified parameter. To the extent that the plain language of the claims relying on such words of approximation as contemplated in the foregoing are clear and uncontradicted by anything in the written description herein or the figures thereof, it is improper to rely upon the present written description, the figures, or the prosecution history to add limitations to any of the claim of the present invention with respect to such words of approximation as contemplated in the foregoing. That is, under such circumstances, relying on the written description and prosecution history to reject the ordinary and customary meanings of the words themselves is impermissible. See, for example, Liquid Dynamics Corp. v. Vaughan Co., 355 F.3d 1361, 69 USPQ2d 1595, 1600-01 (Fed. Cir. 2004). The plain language of phrase 2 requires a “substantial helical flow.” The term “substantial” is a meaningful modifier implying “approximate,” rather than “perfect.” In Cordis Corp. v. Medtronic AVE, Inc., 339 F.3d 1352, 1361 (Fed. Cir. 2003), the district court imposed a precise numeric constraint on the term “substantially uniform thickness.” We noted that the proper interpretation of this term was “of largely or approximately uniform thickness” unless something in the prosecution history imposed the “clear and unmistakable disclaimer” needed for narrowing beyond this simple-language interpretation. Id. In Anchor Wall Systems v. Rockwood Retaining Walls, Inc., 340 F.3d 1298, 1311 (Fed. Cir. 2003)” Id. at 1311. Similarly, the plain language of claim 1 requires neither a perfectly helical flow nor a flow that returns precisely to the center after one rotation (a limitation that arises only as a logical consequence of requiring a perfectly helical flow).

The reader should appreciate that case law generally recognizes a dual ordinary meaning of such words of approximation, as contemplated in the foregoing, as connoting a term of approximation or a term of magnitude; e.g., see Deering Precision Instruments, L.L.C. v. Vector Distrib. Sys., Inc., 347 F.3d 1314, 68 USPQ2d 1716, 1721 (Fed. Cir. 2003), cert. denied, 124 S. Ct. 1426 (2004) where the court was asked to construe the meaning of the term “substantially” in a patent claim. Also see Epcon, 279 F.3d at 1031 (“The phrase ‘substantially constant’ denotes language of approximation, while the phrase ‘substantially below’ signifies language of magnitude, i.e., not insubstantial.”). Also, see, e.g., Epcon Gas Sys., Inc. v. Bauer Compressors, Inc., 279 F.3d 1022 (Fed. Cir. 2002) (construing the terms “substantially constant” and “substantially below”); Zodiac Pool Care, Inc. v. Hoffinger Indus., Inc., 206 F.3d 1408 (Fed. Cir. 2000) (construing the term “substantially inward”); York Prods., Inc. v. Cent. Tractor Farm & Family Ctr., 99 F.3d 1568 (Fed. Cir. 1996) (construing the term “substantially the entire height thereof”); Tex. Instruments Inc. v. Cypress Semiconductor Corp., 90 F.3d 1558 (Fed. Cir. 1996) (construing the term “substantially in the common plane”). In conducting their analysis, the court instructed to begin with the ordinary meaning of the claim terms to one of ordinary skill in the art. Prima Tek, 318 F.3d at 1148. Reference to dictionaries and our cases indicates that the term “substantially” has numerous ordinary meanings. As the district court stated, “substantially” can mean “significantly” or “considerably.” The term “substantially” can also mean “largely” or “essentially.” Webster's New 20th Century Dictionary 1817 (1983).

Words of approximation, as contemplated in the foregoing, may also be used in phrases establishing approximate ranges or limits, where the end points are inclusive and approximate, not perfect; e.g., see AK Steel Corp. v. Sollac, 344 F.3d 1234, 68 USPQ2d 1280, 1285 (Fed. Cir. 2003) where it where the court said [W]e conclude that the ordinary meaning of the phrase “up to about 10%” includes the “about 10%” endpoint. As pointed out by AK Steel, when an object of the preposition “up to” is nonnumeric, the most natural meaning is to exclude the object (e.g., painting the wall up to the door). On the other hand, as pointed out by Sollac, when the object is a numerical limit, the normal meaning is to include that upper numerical limit (e.g., counting up to ten, seating capacity for up to seven passengers). Because we have here a numerical limit—“about 10%”—the ordinary meaning is that that endpoint is included.

In the present specification and claims, a goal of employment of such words of approximation, as contemplated in the foregoing, is to avoid a strict numerical boundary to the modified specified parameter, as sanctioned by Pall Corp. v. Micron Separations, Inc., 66 F.3d 1211, 1217, 36 USPQ2d 1225, 1229 (Fed. Cir. 1995) where it states “It is well established that when the term “substantially” serves reasonably to describe the subject matter so that its scope would be understood by persons in the field of the invention, and to distinguish the claimed subject matter from the prior art, it is not indefinite.” Likewise see Verve LLC v. Crane Cams Inc., 311 F.3d 1116, 65 USPQ2d 1051, 1054 (Fed. Cir. 2002). Expressions such as “substantially” are used in patent documents when warranted by the nature of the invention, in order to accommodate the minor variations that may be appropriate to secure the invention. Such usage may well satisfy the charge to “particularly point out and distinctly claim” the invention, 35 U.S.C. § 112, and indeed may be necessary in order to provide the inventor with the benefit of his invention. In Andrew Corp. v. Gabriel Elecs. Inc., 847 F.2d 819, 821-22, 6 USPQ2d 2010, 2013 (Fed. Cir. 1988) the court explained that usages such as “substantially equal” and “closely approximate” may serve to describe the invention with precision appropriate to the technology and without intruding on the prior art. The court again explained in Ecolab Inc. v. Envirochem, Inc., 264 F.3d 1358, 1367, 60 USPQ2d 1173, 1179 (Fed. Cir. 2001) that “like the term ‘about,’ the term ‘substantially’ is a descriptive term commonly used in patent claims to ‘avoid a strict numerical boundary to the specified parameter, see Ecolab Inc. v. Envirochem Inc., 264 F.3d 1358, 60 USPQ2d 1173, 1179 (Fed. Cir. 2001) where the court found that the use of the term “substantially” to modify the term “uniform” does not render this phrase so unclear such that there is no means by which to ascertain the claim scope.

Similarly, other courts have noted that like the term “about,” the term “substantially” is a descriptive term commonly used in patent claims to “avoid a strict numerical boundary to the specified parameter.”; e.g., see Pall Corp. v. Micron Seps., 66 F.3d 1211, 1217, 36 USPQ2d 1225, 1229 (Fed. Cir. 1995); see, e.g., Andrew Corp. v. Gabriel Elecs. Inc., 847 F.2d 819, 821-22, 6 USPQ2d 2010, 2013 (Fed. Cir. 1988) (noting that terms such as “approach each other,” “close to,” “substantially equal,” and “closely approximate” are ubiquitously used in patent claims and that such usages, when serving reasonably to describe the claimed subject matter to those of skill in the field of the invention, and to distinguish the claimed subject matter from the prior art, have been accepted in patent examination and upheld by the courts). In this case, “substantially” avoids the strict 100% nonuniformity boundary.

Indeed, the foregoing sanctioning of such words of approximation, as contemplated in the foregoing, has been established as early as 1939, see Ex parte Mallory, 52 USPQ 297, 297 (Pat. Off. Bd. App. 1941) where, for example, the court said “the claims specify that the film is “substantially” eliminated and for the intended purpose, it is believed that the slight portion of the film which may remain is negligible. We are of the view, therefore, that the claims may be regarded as sufficiently accurate.” Similarly, In re Hutchison, 104 F.2d 829, 42 USPQ 90, 93 (C.C.P.A. 1939) the court said “It is realized that “substantial distance” is a relative and somewhat indefinite term, or phrase, but terms and phrases of this character are not uncommon in patents in cases where, according to the art involved, the meaning can be determined with reasonable clearness.”

Hence, for at least the forgoing reason, Applicants submit that it is improper for any examiner to hold as indefinite any claims of the present patent that employ any words of approximation.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will be described in detail below with reference to embodiments thereof as illustrated in the accompanying drawings.

References to a “device,” an “apparatus,” a “system,” etc., in the preamble of a claim should be construed broadly to mean “any structure meeting the claim terms” exempt for any specific structure(s)/type(s) that has/(have) been explicitly disavowed or excluded or admitted/implied as prior art in the present specification or incapable of enabling an object/aspect/goal of the invention. Furthermore, where the present specification discloses an object, aspect, function, goal, result, or advantage of the invention that a specific prior art structure and/or method step is similarly capable of performing yet in a very different way, the present invention disclosure is intended to and shall also implicitly include and cover additional corresponding alternative embodiments that are otherwise identical to that explicitly disclosed except that they exclude such prior art structure(s)/step(s), and shall accordingly be deemed as providing sufficient disclosure to support a corresponding negative limitation in a claim claiming such alternative embodiment(s), which exclude such very different prior art structure(s)/step(s) way(s).

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” “some embodiments,” “embodiments of the invention,” etc., may indicate that the embodiment(s) of the invention so described may include a particular feature, structure, or characteristic, but not every possible embodiment of the invention necessarily includes the particular feature, structure, or characteristic. Further, repeated use of the phrase “in one embodiment,” or “in an exemplary embodiment,” “an embodiment,” do not necessarily refer to the same embodiment, although they may. Moreover, any use of phrases like “embodiments” in connection with “the invention” are never meant to characterize that all embodiments of the invention must include the particular feature, structure, or characteristic, and should instead be understood to mean “at least some embodiments of the invention” include the stated particular feature, structure, or characteristic.

References to “user”, or any similar term, as used herein, may mean a human or non-human user thereof. Moreover, “user”, or any similar term, as used herein, unless expressly stipulated otherwise, is contemplated to mean users at any stage of the usage process, to include, without limitation, direct user(s), intermediate user(s), indirect user(s), and end user(s). The meaning of “user”, or any similar term, as used herein, should not be otherwise inferred, or induced by any pattern(s) of description, embodiments, examples, or referenced prior-art that may (or may not) be provided in the present patent.

References to “end user”, or any similar term, as used herein, is generally intended to mean late-stage user(s) as opposed to early-stage user(s). Hence, it is contemplated that there may be a multiplicity of different types of “end user” near the end stage of the usage process. Where applicable, especially with respect to distribution channels of embodiments of the invention comprising consumed retail products/services thereof (as opposed to sellers/vendors or Original Equipment Manufacturers), examples of an “end user” may include, without limitation, a “consumer”, “buyer”, “customer”, “purchaser”, “shopper”, “enjoyer”, “viewer”, or individual person or non-human thing benefiting in any way, directly or indirectly, from use of. or interaction, with some aspect of the present invention.

In some situations, some embodiments of the present invention may provide beneficial usage to more than one stage or type of usage in the foregoing usage process. In such cases where multiple embodiments targeting various stages of the usage process are described, references to “end user”, or any similar term, as used therein, are generally intended to not include the user that is the furthest removed, in the foregoing usage process, from the final user therein of an embodiment of the present invention.

Where applicable, especially with respect to retail distribution channels of embodiments of the invention, intermediate user(s) may include, without limitation, any individual person or non-human thing benefiting in any way, directly or indirectly, from use of, or interaction with, some aspect of the present invention with respect to selling, vending, Original Equipment Manufacturing, marketing, merchandising, distributing, service providing, and the like thereof.

References to “person”, “individual”, “human”, “a party”, “animal”, “creature”, or any similar term, as used herein, even if the context or particular embodiment implies living user, maker, or participant, it should be understood that such characterizations are sole by way of example, and not limitation, in that it is contemplated that any such usage, making, or participation by a living entity in connection with making, using, and/or participating, in any way, with embodiments of the present invention may be substituted by such similar performed by a suitably configured non-living entity, to include, without limitation, automated machines, robots, humanoids, computational systems, information processing systems, artificially intelligent systems, and the like. It is further contemplated that those skilled in the art will readily recognize the practical situations where such living makers, users, and/or participants with embodiments of the present invention may be in whole, or in part, replaced with such non-living makers, users, and/or participants with embodiments of the present invention. Likewise, when those skilled in the art identify such practical situations where such living makers, users, and/or participants with embodiments of the present invention may be in whole, or in part, replaced with such non-living makers, it will be readily apparent in light of the teachings of the present invention how to adapt the described embodiments to be suitable for such non-living makers, users, and/or participants with embodiments of the present invention. Thus, the invention is thus to also cover all such modifications, equivalents, and alternatives falling within the spirit and scope of such adaptations and modifications, at least in part, for such non-living entities.

Headings provided herein are for convenience and are not to be taken as limiting the disclosure in any way.

The enumerated listing of items does not imply that any or all of the items are mutually exclusive, unless expressly specified otherwise.

It is understood that the use of specific component, device and/or parameter names are for example only and not meant to imply any limitations on the invention. The invention may thus be implemented with different nomenclature/terminology utilized to describe the mechanisms/units/structures/components/devices/parameters herein, without limitation. Each term utilized herein is to be given its broadest interpretation given the context in which that term is utilized.

Terminology. The following paragraphs provide definitions and/or context for terms found in this disclosure (including the appended claims):

“Comprising” And “contain” and variations of them—Such terms are open-ended and mean “including but not limited to”. When employed in the appended claims, this term does not foreclose additional structure or steps. Consider a claim that recites: “A memory controller comprising a system cache . . . .” Such a claim does not foreclose the memory controller from including additional components (e.g., a memory channel unit, a switch).

“Configured To.” Various units, circuits, or other components may be described or claimed as “configured to” perform a task or tasks. In such contexts, “configured to” or “operable for” is used to connote structure by indicating that the mechanisms/units/circuits/components include structure (e.g., circuitry and/or mechanisms) that performs the task or tasks during operation. As such, the mechanisms/unit/circuit/component can be said to be configured to (or be operable) for perform(ing) the task even when the specified mechanisms/unit/circuit/component is not currently operational (e.g., is not on). The mechanisms/units/circuits/components used with the “configured to” or “operable for” language include hardware—for example, mechanisms, structures, electronics, circuits, memory storing program instructions executable to implement the operation, etc. Reciting that a mechanism/unit/circuit/component is “configured to” or “operable for” perform(ing) one or more tasks is expressly intended not to invoke 35 U.S.C. sctn.112, sixth paragraph, for that mechanism/unit/circuit/component. “Configured to” may also include adapting a manufacturing process to fabricate devices or components that are adapted to implement or perform one or more tasks.

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While B may be a factor that affects the determination of A, such a phrase does not foreclose the determination of A from also being based on C. In other instances, A may be determined based solely on B.

The terms “a”, “an” and “the” mean “one or more”, unless expressly specified otherwise.

All terms of exemplary language (e.g., including, without limitation, “such as”, “like”, “for example”, “for instance”, “similar to”, etc.) are not exclusive of any other, potentially, unrelated, types of examples; thus, implicitly mean “by way of example, and not limitation . . . ”, unless expressly specified otherwise.

Unless otherwise indicated, all numbers expressing conditions, concentrations, dimensions, and so forth used in the specification and claims are to be understood as being modified in all instances by the term “about.” Accordingly, unless indicated to the contrary, the numerical parameters set forth in the following specification and attached claims are approximations that may vary depending at least upon a specific analytical technique.

The term “comprising,” which is synonymous with “including,” “containing,” or “characterized by” is inclusive or open-ended and does not exclude additional, unrecited elements or method steps. “Comprising” is a term of art used in claim language which means that the named claim elements are essential, but other claim elements may be added and still form a construct within the scope of the claim.

As used herein, the phase “consisting of” excludes any element, step, or ingredient not specified in the claim. When the phrase “consists of” (or variations thereof) appears in a clause of the body of a claim, rather than immediately following the preamble, it limits only the element set forth in that clause; other elements are not excluded from the claim as a whole. As used herein, the phase “consisting essentially of” and “consisting of” limits the scope of a claim to the specified elements or method steps, plus those that do not materially affect the basis and novel characteristic(s) of the claimed subject matter (see Norian Corp. v Stryker Corp., 363 F.3d 1321, 1331-32, 70 USPQ2d 1508, Fed. Cir. 2004). Moreover, for any claim of the present invention which claims an embodiment “consisting essentially of” or “consisting of” a certain set of elements of any herein described embodiment it shall be understood as obvious by those skilled in the art that the present invention also covers all possible varying scope variants of any described embodiment(s) that are each exclusively (i.e., “consisting essentially of”) functional subsets or functional combination thereof such that each of these plurality of exclusive varying scope variants each consists essentially of any functional subset(s) and/or functional combination(s) of any set of elements of any described embodiment(s) to the exclusion of any others not set forth therein. That is, it is contemplated that it will be obvious to those skilled how to create a multiplicity of alternate embodiments of the present invention that simply consisting essentially of a certain functional combination of elements of any described embodiment(s) to the exclusion of any others not set forth therein, and the invention thus covers all such exclusive embodiments as if they were each described herein.

With respect to the terms “comprising,” “consisting of,” and “consisting essentially of,” where one of these three terms is used herein, the disclosed and claimed subject matter may include the use of either of the other two terms. Thus, in some embodiments not otherwise explicitly recited, any instance of “comprising” may be replaced by “consisting of” or, alternatively, by “consisting essentially of”, and thus, for the purposes of claim support and construction for “consisting of” format claims, such replacements operate to create yet other alternative embodiments “consisting essentially of” only the elements recited in the original “comprising” embodiment to the exclusion of all other elements.

Moreover, any claim limitation phrased in functional limitation terms covered by 35 USC § 112(6) (post AIA 112(f)) which has a preamble invoking the closed terms “consisting of,” or “consisting essentially of,” should be understood to mean that the corresponding structure(s) disclosed herein define the exact metes and bounds of what the so claimed invention embodiment(s) consists of, or consisting essentially of, to the exclusion of any other elements which do not materially affect the intended purpose of the so claimed embodiment(s).

Devices or system modules that are in at least general communication with each other need not be in continuous communication with each other, unless expressly specified otherwise. In addition, devices or system modules that are in at least general communication with each other may communicate directly or indirectly through one or more intermediaries. Moreover, it is understood that any system components described or named in any embodiment or claimed herein may be grouped or sub-grouped (and accordingly implicitly renamed) in any combination or sub-combination as those skilled in the art can imagine as suitable for the particular application, and still be within the scope and spirit of the claimed embodiments of the present invention. For an example of what this means, if the invention was a controller of a motor and a valve and the embodiments and claims articulated those components as being separately grouped and connected, applying the foregoing would mean that such an invention and claims would also implicitly cover the valve being grouped inside the motor and the controller being a remote controller with no direct physical connection to the motor or internalized valve, as such the claimed invention is contemplated to cover all ways of grouping and/or adding of intermediate components or systems that still substantially achieve the intended result of the invention.

A description of an embodiment with several components in communication with each other does not imply that all such components are required. On the contrary a variety of optional components is described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

It is to be understood that any exact measurements/dimensions or particular construction materials indicated herein are solely provided as examples of suitable configurations and are not intended to be limiting in any way. Depending on the needs of the particular application, those skilled in the art will readily recognize, in light of the following teachings, a multiplicity of suitable alternative implementation details.

A “computer” may refer to one or more apparatus and/or one or more systems that are capable of accepting a structured input, processing the structured input according to prescribed rules, and producing results of the processing as output. Examples of a computer may include: a computer; a stationary and/or portable computer; a computer having a single processor, multiple processors, or multi-core processors, which may operate in parallel and/or not in parallel; a general purpose computer; a supercomputer; a mainframe; a super mini-computer; a mini-computer; a workstation; a micro-computer; a server; a client; an interactive television; a web appliance; a telecommunications device with internet access; a hybrid combination of a computer and an interactive television; a portable computer; a tablet personal computer (PC); a personal digital assistant (PDA); a portable telephone; application-specific hardware to emulate a computer and/or software, such as, for example, a digital signal processor (DSP), a field-programmable gate array (FPGA), an application specific integrated circuit (ASIC), an application specific instruction-set processor (ASIP), a chip, chips, a system on a chip, or a chip set; a data acquisition device; an optical computer; a quantum computer; a biological computer; and generally, an apparatus that may accept data, process data according to one or more stored software programs, generate results, and typically include input, output, storage, arithmetic, logic, and control units.

Those of skill in the art will appreciate that where appropriate, some embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Where appropriate, embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

“Software” may refer to prescribed rules to operate a computer. Examples of software may include: code segments in one or more computer-readable languages; graphical and or/textual instructions; applets; pre-compiled code; interpreted code; compiled code; and computer programs.

The example embodiments described herein can be implemented in an operating environment comprising computer-executable instructions (e.g., software) installed on a computer, in hardware, or in a combination of software and hardware. The computer-executable instructions can be written in a computer programming language or can be embodied in firmware logic. If written in a programming language conforming to a recognized standard, such instructions can be executed on a variety of hardware platforms and for interfaces to a variety of operating systems. Although not limited thereto, computer software program code for carrying out operations for aspects of the present invention can be written in any combination of one or more suitable programming languages, including an object oriented programming languages and/or conventional procedural programming languages, and/or programming languages such as, for example, Hypertext Markup Language (HTML), Dynamic HTML, Extensible Markup Language (XML), Extensible Stylesheet Language (XSL), Document Style Semantics and Specification Language (DSSSL), Cascading Style Sheets (CSS), Synchronized Multimedia Integration Language (SMIL), Wireless Markup Language (WML), Java™, Jini™, C, C++, Smalltalk, Perl, UNIX Shell, Visual Basic or Visual Basic Script, Virtual Reality Markup Language (VRML), ColdFusion™ or other compilers, assemblers, interpreters or other computer languages or platforms.

Computer program code for carrying out operations for aspects of the present invention may be written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

A network is a collection of links and nodes (e.g., multiple computers and/or other devices connected together) arranged so that information may be passed from one part of the network to another over multiple links and through various nodes. Examples of networks include the Internet, the public switched telephone network, the global Telex network, computer networks (e.g., an intranet, an extranet, a local-area network, or a wide-area network), wired networks, and wireless networks.

The Internet is a worldwide network of computers and computer networks arranged to allow the easy and robust exchange of information between computer users. Hundreds of millions of people around the world have access to computers connected to the Internet via Internet Service Providers (ISPs). Content providers (e.g., website owners or operators) place multimedia information (e.g., text, graphics, audio, video, animation, and other forms of data) at specific locations on the Internet referred to as webpages. Websites comprise a collection of connected, or otherwise related, webpages. The combination of all the websites and their corresponding webpages on the Internet is generally known as the World Wide Web (WWW) or simply the Web.

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The flowchart and/or block diagrams in the figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

Further, although process steps, method steps, algorithms or the like may be described in a sequential order, such processes, methods, and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously.

It will be readily apparent that the various methods and algorithms described herein may be implemented by, e.g., appropriately programmed general purpose computers and computing devices. Typically, a processor (e.g., a microprocessor) will receive instructions from a memory or like device, and execute those instructions, thereby performing a process defined by those instructions. Further, programs that implement such methods and algorithms may be stored and transmitted using a variety of known media.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

The functionality and/or the features of a device may be alternatively embodied by one or more other devices which are not explicitly described as having such functionality/features. Thus, other embodiments of the present invention need not include the device itself.

The term “computer-readable medium” as used herein refers to any medium that participates in providing data (e.g., instructions) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random-access memory (DRAM), which typically constitutes the main memory. Transmission media include coaxial cables, copper wire and fiber optics, including the wires that comprise a system bus coupled to the processor. Transmission media may include or convey acoustic waves, light waves, and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, removable media, flash memory, a “memory stick”, any other memory chip or cartridge, a carrier wave as described hereinafter, or any other medium from which a computer can read.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards, or protocols, such as Bluetooth, TDMA, CDMA, 3G.

Where databases are described, it will be understood by one of ordinary skill in the art that (i) alternative database structures to those described may be readily employed, (ii) other memory structures besides databases may be readily employed. Any schematic illustrations and accompanying descriptions of any sample databases presented herein are exemplary arrangements for stored representations of information. Any number of other arrangements may be employed besides those suggested by the tables shown. Similarly, any illustrated entries of the databases represent exemplary information only; those skilled in the art will understand that the number and content of the entries can be different from those illustrated herein. Further, despite any depiction of the databases as tables, an object-based model could be used to store and manipulate the data types of the present invention and likewise, object methods or behaviors can be used to implement the processes of the present invention.

A “computer system” may refer to a system having one or more computers, where each computer may include a computer-readable medium embodying software to operate the computer or one or more of its components. Examples of a computer system may include: a distributed computer system for processing information via computer systems linked by a network; two or more computer systems connected together via a network for transmitting and/or receiving information between the computer systems; a computer system including two or more processors within a single computer; and one or more apparatuses and/or one or more systems that may accept data, may process data in accordance with one or more stored software programs, may generate results, and typically may include input, output, storage, arithmetic, logic, and control units.

A “network” may refer to a number of computers and associated devices that may be connected by communication facilities. A network may involve permanent connections such as cables or temporary connections such as those made through telephone or other communication links. A network may further include hard-wired connections (e.g., coaxial cable, twisted pair, optical fiber, waveguides, etc.) and/or wireless connections (e.g., radio frequency waveforms, free-space optical waveforms, acoustic waveforms, etc.). Examples of a network may include: an internet, such as the Internet; an intranet; a local area network (LAN); a wide area network (WAN); and a combination of networks, such as an internet and an intranet.

As used herein, the “client-side” application should be broadly construed to refer to an application, a page associated with that application, or some other resource or function invoked by a client-side request to the application. A “browser” as used herein is not intended to refer to any specific browser (e.g., Internet Explorer, Safari, FireFox, or the like), but should be broadly construed to refer to any client-side rendering engine that can access and display Internet-accessible resources. A “rich” client typically refers to a non-HTTP based client-side application, such as an SSH or CFIS client. Further, while typically the client-server interactions occur using HTTP, this is not a limitation either. The client server interaction may be formatted to conform to the Simple Object Access Protocol (SOAP) and travel over HTTP (over the public Internet), FTP, or any other reliable transport mechanism (such as IBM®. MQSeries® technologies and CORBA, for transport over an enterprise intranet) may be used. Any application or functionality described herein may be implemented as native code, by providing hooks into another application, by facilitating use of the mechanism as a plug-in, by linking to the mechanism, and the like.

Exemplary networks may operate with any of a number of protocols, such as Internet protocol (IP), asynchronous transfer mode (ATM), and/or synchronous optical network (SONET), user datagram protocol (UDP), IEEE 802.x, etc.

Embodiments of the present invention may include apparatuses for performing the operations disclosed herein. An apparatus may be specially constructed for the desired purposes, or it may comprise a general-purpose device selectively activated or reconfigured by a program stored in the device.

Embodiments of the invention may also be implemented in one or a combination of hardware, firmware, and software. They may be implemented as instructions stored on a machine-readable medium, which may be read and executed by a computing platform to perform the operations described herein.

More specifically, as will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

In the following description and claims, the terms “computer program medium” and “computer readable medium” may be used to generally refer to media such as, but not limited to, removable storage drives, a hard disk installed in hard disk drive, and the like. These computer program products may provide software to a computer system. Embodiments of the invention may be directed to such computer program products.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. It should be understood, however, that all of these and similar terms are to be associated with the appropriate physical quantities and are merely convenient labels applied to these quantities.

Unless specifically stated otherwise, and as may be apparent from the following description and claims, it should be appreciated that throughout the specification descriptions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Additionally, the phrase “configured to” or “operable for” can include generic structure (e.g., generic circuitry) that is manipulated by software and/or firmware (e.g., an FPGA or a general-purpose processor executing software) to operate in a manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks.

In a similar manner, the term “processor” may refer to any device or portion of a device that processes electronic data from registers and/or memory to transform that electronic data into other electronic data that may be stored in registers and/or memory. A “computing platform” may comprise one or more processors.

Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

While a non-transitory computer readable medium includes, but is not limited to, a hard drive, compact disc, flash memory, volatile memory, random access memory, magnetic memory, optical memory, semiconductor-based memory, phase change memory, optical memory, periodically refreshed memory, and the like; the non-transitory computer readable medium, however, does not include a pure transitory signal per se; i.e., where the medium itself is transitory.

It is to be understood that any exact measurements/dimensions or particular construction materials indicated herein are solely provided as examples of suitable configurations and are not intended to be limiting in any way. Depending on the needs of the particular application, those skilled in the art will readily recognize, in light of the following teachings, a multiplicity of suitable alternative implementation details.

In some embodiments of the present invention and variations thereof, relate to wagering bingo50 card game. In one embodiment of the present invention, bingo50 game makes it possible for all skill level players to compete and win as opposed to poker game where skilled players have a big advantage over other players. Bingo50 game incorporates a series of decisions (bets) as opposed to regular bingo which just makes the player follow along. Bingo50 game may be played using paper and/or electronic bingo50 cards. Bingo50 may include a card deck with 10 B's, 10 I's, 10 N's, 10 G's, and 10 O's. Each pair of the same numbered letter cards may include numbers 1, 2, 3, 4, 5 and of each pair with the same numbered letter cards, one of the two cards may have a symbol. The game is played where each player receives a predetermined number of hold cards and has to either bet or fold their hold cards based on their holding versus the holdings of every other player. An ante bet is placed by each player before each player receives their hold cards. Once each player has received their hold cards, another bet is placed by each player to continue with the hand. An initial community card is placed face up for all players to use in making a bingo. Each player still in the hand has to place another bet to continue with the hand. This system of community card dealt up and bet continues for the duration of the hand till one or more players either make a bingo or 5 of the same letter and win the pot (e.g., all the accumulated bets). As the game continues each player either folds or bets their hold cards based on a series of the community cards being dealt to make the bingo or the five (5) of the same letters before any other player to win the hand. The game may include a continuous betting format played with all community cards dealt up. One or more players may win the hand by completing the word B-I-N-G-0 or five (5) of the same letters (e.g. B-B-B-B-B or or N-N-N-N-N or G-G-G-G-G or O-O-O-O-O) from any combination of player hold cards and community cards.

In some embodiment, the game may include an electronic/digital bingo50 card game system with a memory device that stores one or more instructions and a processor. The one or more instructions may be executed by the processor in response to an occurrence of a bingo game activation/triggering event such as but not limited to, starting a new game with a press of a button or a tap on a touch screen. The instructions may further cause the processor to initially determine the number of players, create a list of the players and an amount of wagering money each player brings to the game, an amount of ante bet chosen by the players, an amount of maximum, minimum, or preset bet, the number of hold cards to distribute to each player, a preset condition of the distributed hold cards, and the number of community cards to deal. Display initial setup showing all the players, community cards placement, deck cards, pot, etc. The instructions may further cause the processor to determine which player wagers the ante bet, designate which player is active (e.g. placed an ante bet) or inactive (e.g. folds the hold card), distribute hold cards to each active player, deals two community cards face up, determine which player puts up a continuity bet, determine pot amount, determine whose hold cards in combination with the community cards completes B-I-N-G-O or five (5) of the same letters, declare a winner(s), reshuffle the deck of cards, etc.

The present invention will now be described in detail with reference to embodiments thereof as illustrated in the accompanying drawings.

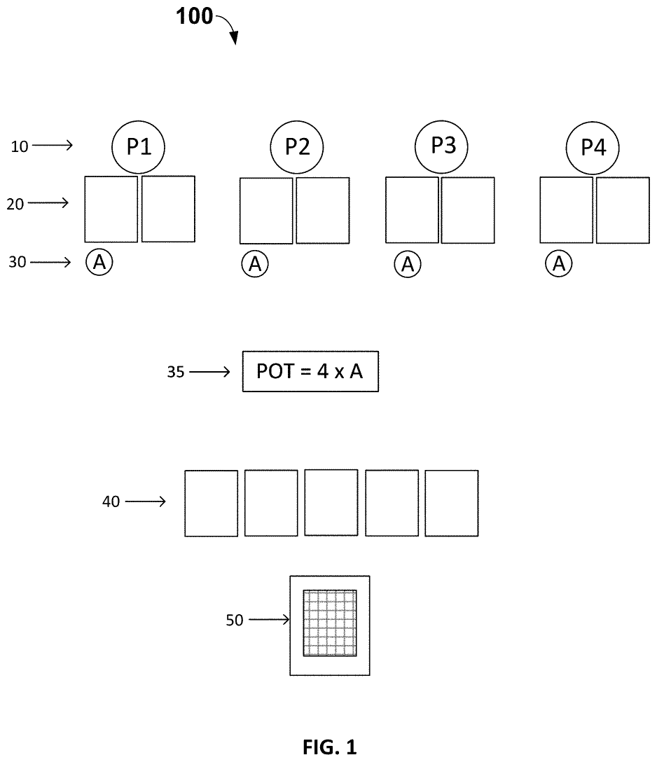

FIG. 1 is an illustration of an exemplary BINGO50-STEADY game play in an initial step, in accordance with an embodiment of the present invention. In one embodiment, the base game, BINGO50-STEADY 100, is played with an ante bet placed by each player before each player receives their hold cards. Once each player has received their hold cards another bet is placed by each player to continue with the hand. An initial community card may be placed face up for all players to use in making a bingo. Each player still in the hand may place another bet to continue with the hand or fold their hold cards. The system of community card dealt up and placing bets for the duration of the hand continues till one or more players either make a bingo (e.g., completes B-I-N-G-O) or 5 of the same letter and win the pot (e.g., accumulation of all the bets).

In some embodiment, BINGO50 is a bingo card game played by 2 to 8 players. Referring to FIGS. 1 through 8, these figures show an example of BINGO50-STEADY game play 100 with four players 10 (e.g., P1-P4). In other embodiment, the game may be played between 2 to 8 players (e.g., P1-P8). FIG. 1 shows four (4) players P1 through P4. Each player 10 may put up an ante bet (A) 30 to be considered an active player. POT 35 may represent the total bet by all the players. For example, the total bet is approximately equal to the number of players 10 multiplied by the ante bet (A) 30, 4×(A). If the ante bet (A) is equal to 5, then the POT is equal to 20 (e.g., 4×5=20). If the ante (A) bet is equal to 10, then the POT is equal to 40 (e.g., 4×10=40). Referring to FIG. 1, no hold cards 20 and/or community card(s) 40 have been dealt yet. Hold card 20 and/or community card 40 may be dealt from card deck 50.

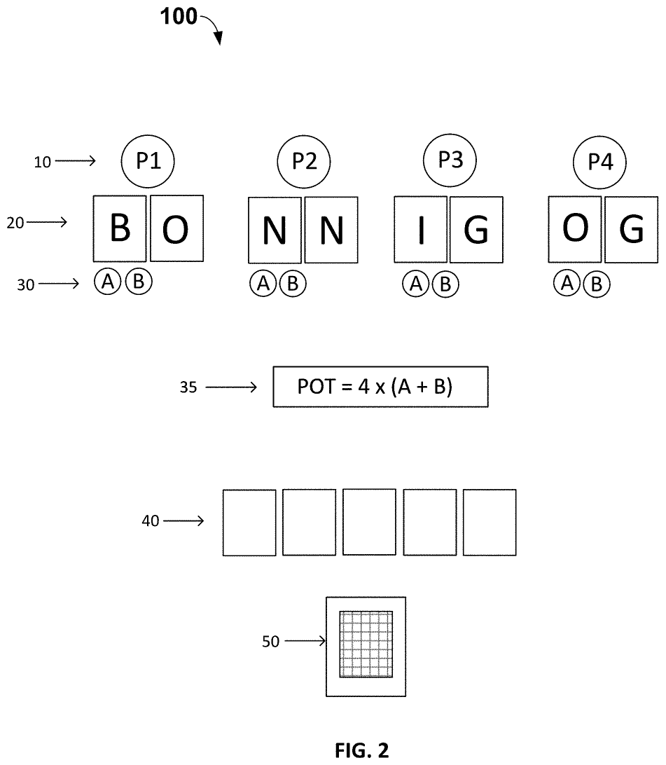

FIG. 2 is an illustration of an exemplary BINGO50-STEADY game play in a succeeding stage, in accordance with an embodiment of the present invention. Referring to FIG. 2, this figure shows each player 10 receiving two (2) hold cards 20 and putting up a chip bet (B) 30. All hold cards may be dealt face up. Alternatively, the hold cards may be dealt face down. Players may put up a bet to play their hand. On the other hand, players may not have to put up this bet. A player may surrender their hold card and lose only what they have initially put into the pot. If all players have placed a chip bet (B), the pot is approximately equal to the number of players multiplied by the ante bet (A) and chip bet (B), 4×(A+B). For example, if the chip bet (B) is 5, then the total POT is approximately equal to 4×(5+5)=40.

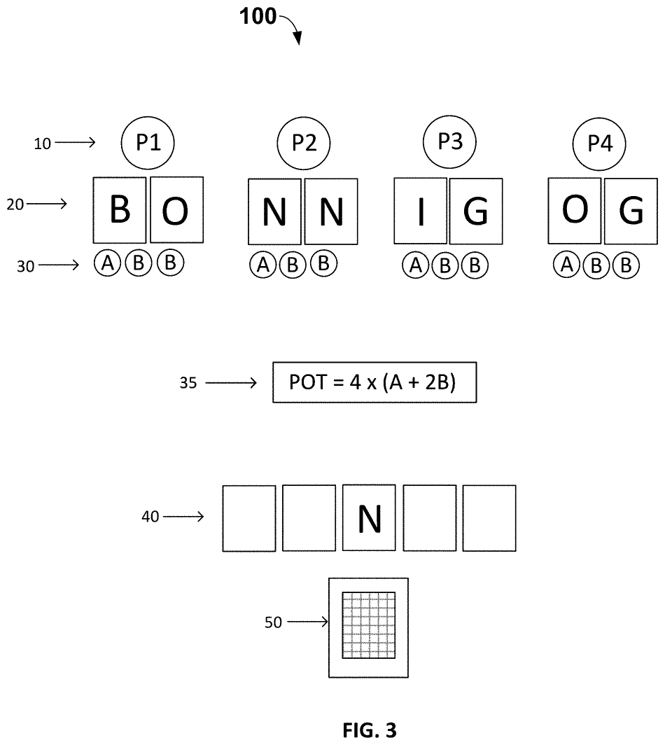

FIG. 3 is an illustration of an exemplary BINGO50-STEADY game play in a subsequent step, in accordance with an embodiment of the present invention. In one embodiment, FIG. 3 shows the first community card 40 (e.g., letter ‘N’) dealt face up and may be used by all players 10. Players 10 have the option of placing a chip bet (B) 30 or folding their hold cards 20 and losing what they have put into the pot. If all players place a bet (B), then the pot is approximately equal to 60. Player 1 (P1) has 3 letters (e.g., B-N-O) to a bingo (e.g., B-I-N-G-O), player 2 (P2) has 3 letters (e.g., N-N-N) to a 5 of the same letter (e.g. N-N-N-N-N), player 3 (P3) has 3 letters (e.g. I-N-G) to a bingo (e.g. B-I-N-G-O), player 4 (P4) has 3 letters (e.g. N-G-O) to a bingo (e.g. B-I-N-G-O).

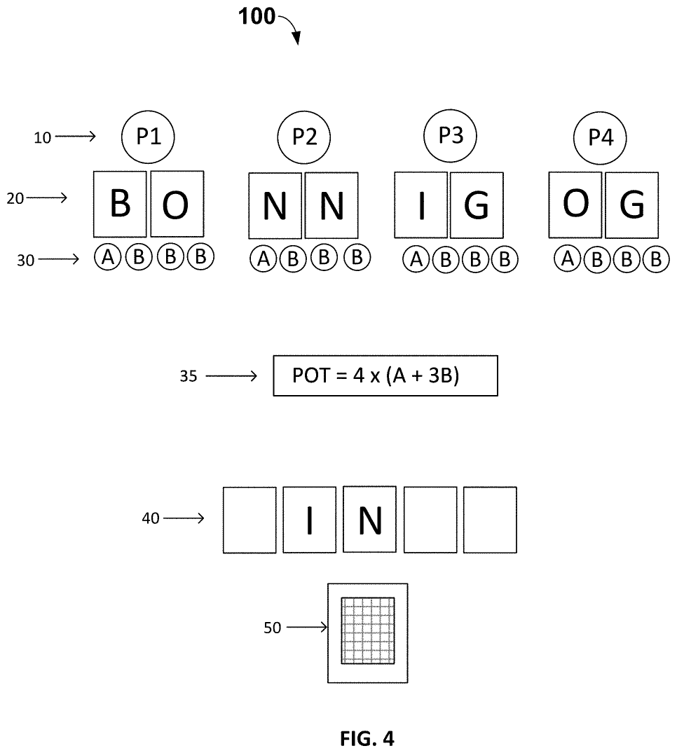

FIG. 4 is an illustration of an exemplary BINGO50-STEADY game play showing a second community card, in accordance with an embodiment of the present invention. In one embodiment, FIG. 4 shows a second community card 35 dealt face up and may be used by all players 10 (community cards 35 may always be used by all players 10). Again, players 10 may bet or fold. If all players 10 put up 5 chip bet (B), then total POT is approximately equal to 80. Player 1 (P1) has 4 letters (e.g. B-I-N-O) to a bingo (e.g. B-I-N-G-O), player 2 (P2) has 2 letters (e.g. I-N) to a bingo and 3 letters (e.g. N-N-N) to a 5 of the same letter, player 3 (P3) has 3 letters (e.g. I-N-G) to a bingo and 2 letters (e.g. I-I) to a 5 of the same letter (e.g. player 4 (P4) has 4 letters (e.g. I-N-G-O) to a bingo.

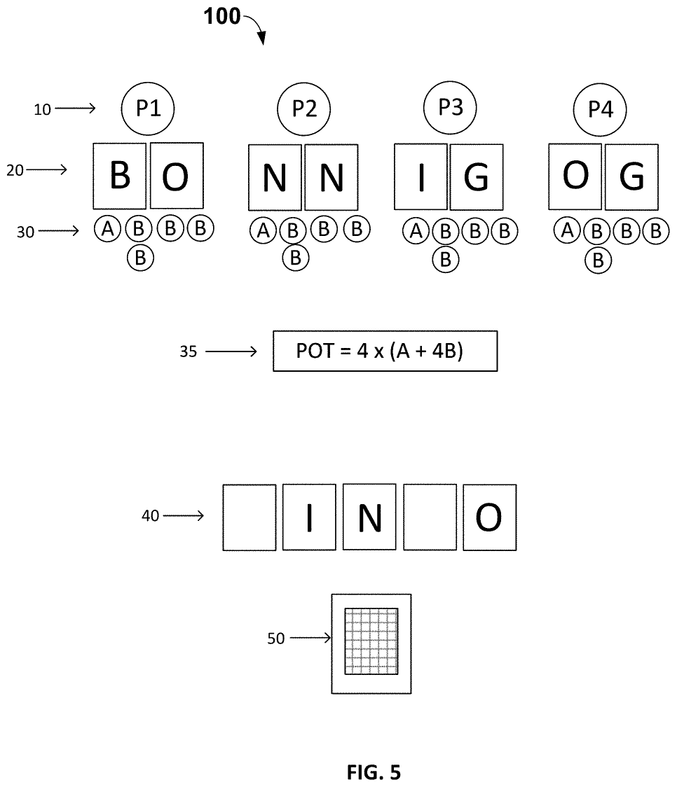

FIG. 5 is an illustration of an exemplary BINGO50-STEADY game play, in accordance with an embodiment of the present invention. In one embodiment, FIG. 5 shows a third community card 40 dealt face up (all cards are dealt face up). All players 10 have put up a fifth bet (B) and are continuing with the hand (no one folded their hold card 20). The pot is approximately equal to 100. Player 1 (P1) is 4 letters to a bingo, player 2 (P2) is 3 letters to a bingo, player 3 (P3) is 4 letters to a bingo, player 4 (P4) is 4 letters to a bingo, all players 10 have a 2 or 3 to a 5 of the same letter.

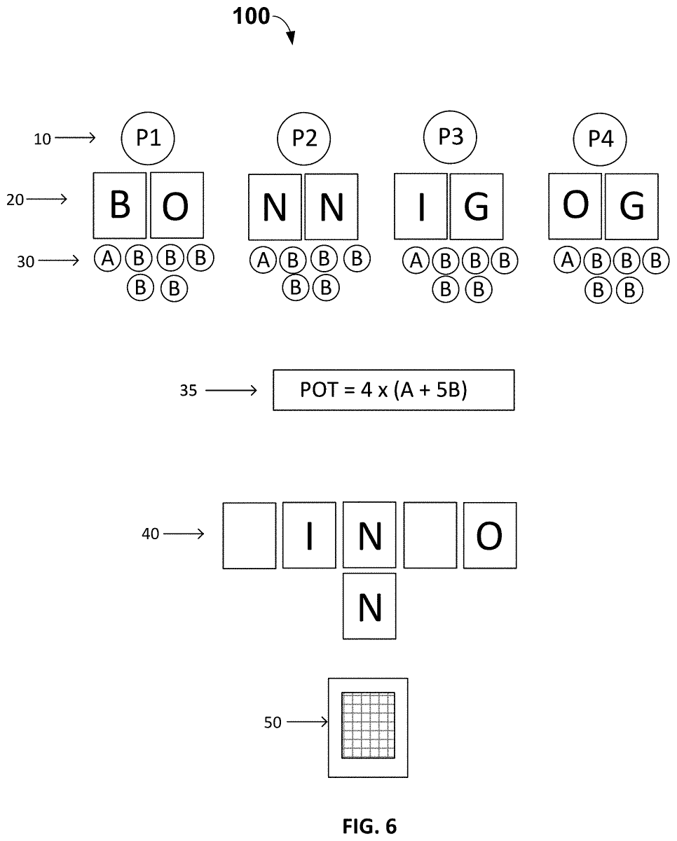

FIG. 6 is an illustration of an exemplary BINGO50-STEADY game play, in accordance with an embodiment of the present invention. In one embodiment, FIG. 6 shows a fourth community card 40 which is a second N and is placed under the N row and only improves player 2's (P2) chance to make a 5 of the same letter (e.g., N-N-N-N-N), no one else has improved their hand. All players 10 continue with a sixth bet (B) and the pot is approximately equal to 120.

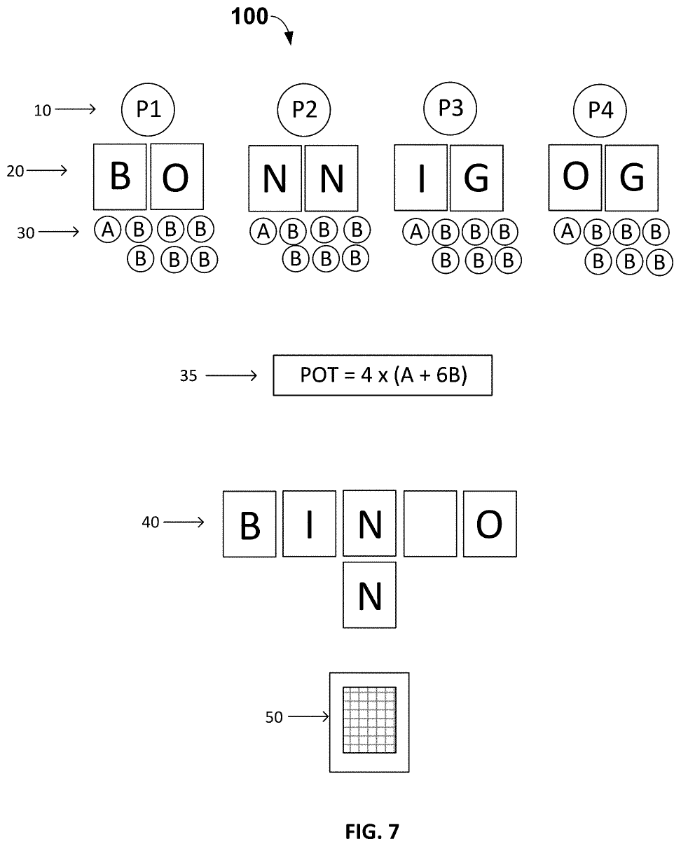

FIG. 7 is an illustration of an exemplary BINGO50-STEADY game play showing a winner situation, in accordance with an embodiment of the present invention. In one embodiment, FIG. 7 shows a fifth community card 40 dealt which is a letter ‘B’ and makes player's 3 (P3) and 4 (P4) have a bingo (e.g., B-I-N-G-O). The pot is shared evenly between the 2 players (P3) and (P4) and all cards (e.g., hold cards and community cards) are collected and shuffled for the next hand.

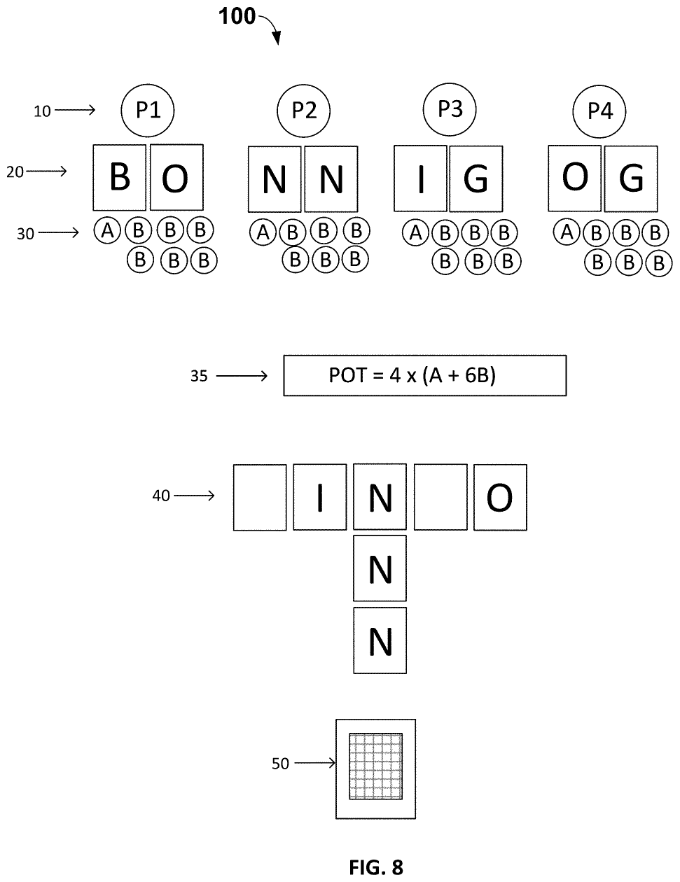

FIG. 8 is an illustration of an exemplary BINGO50-STEADY game play, in accordance with an embodiment of the present invention. In one embodiment, FIG. 8 shows an alternative fifth community card 40. For example, if the fifth community card was not a letter ‘B’ but was a third letter ‘N’, player 2 (P2) would have made a 5 of the same letter (e.g., N-N-N-N-N) and would be awarded the pot.

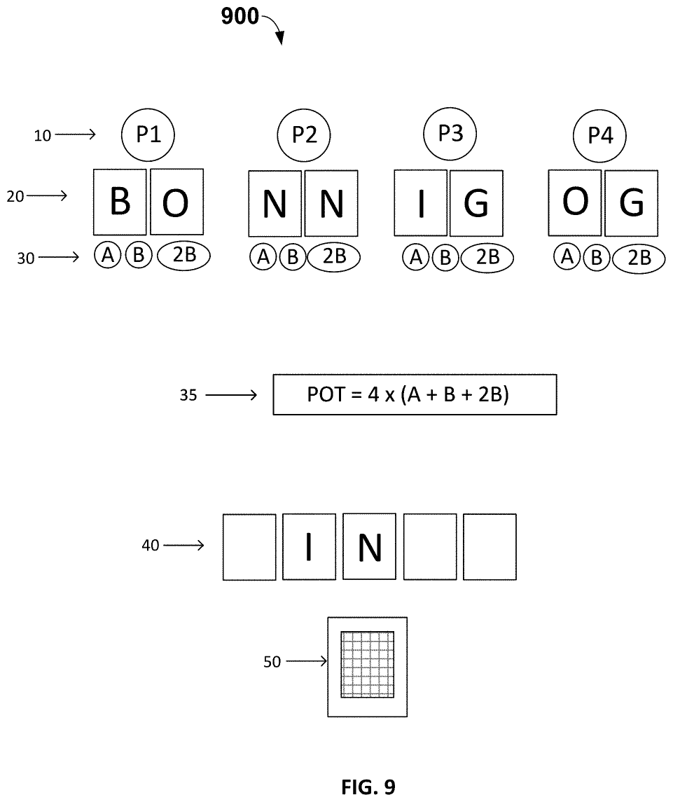

FIG. 9 is an illustration of an exemplary BINGO50-FREEZE game play 900, in accordance with an embodiment of the present invention. In a variation to the BINGO50-STEADY game play, in BINGO50-FREEZE game play 900, instead of a first community card dealt up, there are two (2) community cards dealt up with a double bet (2B) forced on all players to continue with the hand. After the double bet (2B) has been placed by all remaining players 10, all additional community cards are dealt till a player or players win the pot with no additional betting by players.

In some embodiment, FIG. 9 shows a betting variation of a BINGO50-FREEZE game. FIG. 9 replaces FIG. 3 and FIG. 4. FIG. 5 through FIG. 8 would remain the same but would not have the accumulating bet value. For example, FIG. 9 shows the same player hold cards 20 and betting from FIG. 1 and FIG. 2 but with a double bet value of 10 after the two (2) community card flop is dealt face up. The 2-card community flop 40 is the last betting round and players 10 who continue with this double bet value (2B) receive all further community cards with no additional betting. FIG. 5 through FIG. 7 would remain the same but the total pot 35 may be approximately equal to 80 on FIG. 5, FIG. 6, and FIG. 7. Player's 3 (P1) and 4 (P4) would share the pot receiving approximately equal to 40 apiece.

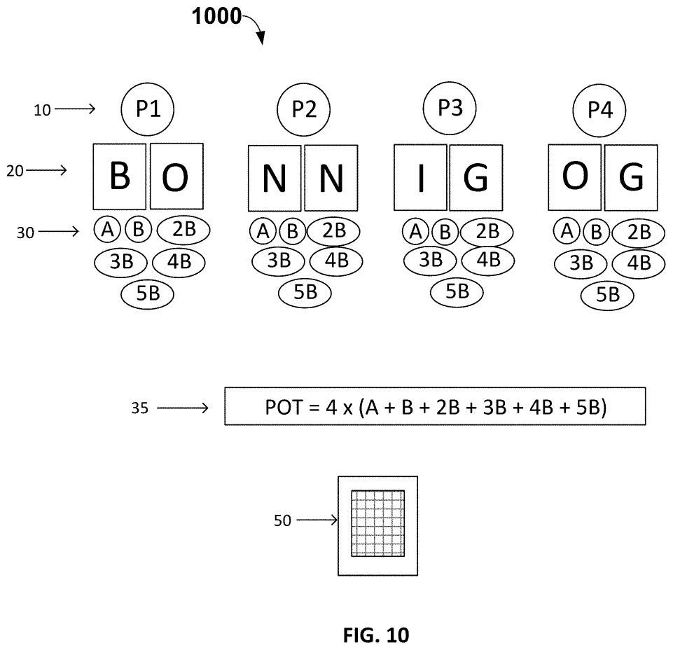

FIG. 10 is an illustration of an exemplary BINGO50-MAX game play, in accordance with an embodiment of the present invention. In a variation to the BINGO50-STEADY game play called Bingo50-MAX 1000, the betting (B) increments are increased in a gradual 1, 2, 3, 4, 5, and so on fashion. The bet after the ante (A) being 1-bet chip point value (B), the hold card bet being a 2-bet value (2B), the first community card bet being a 3-bet value (3B), the 2nd hold card bet being 4 bet value (4B), and so on till a player or players 10 win the pot. For example, in the BINGO50-MAX betting variation, the ante bet (A) is still 5 but further betting rounds have an escalating value of 5 on each round of betting. Second bet is 10, third bet is 15, fourth bet is 20 and so on till the hand is won.

In some embodiment, FIG. 10 shows all the bets 30 for a BINGO50-MAX game 1000 betting variation. Everything in the MAX game is exactly the same as the BINGO50-STEADY GAME except for the escalating bet feature. FIG. 10 shows the bet difference for each player as opposed to FIG. 2 through FIG. 7 in the BINGO50-STEADY GAME. The first bet (B) being 5, the second bet (2B) being 10, the third bet (3B) being 15, the fourth bet (4B) being 20, the fifth bet (5B) being 25, and the sixth bet (6B) being 30. Player's 3 and 4 sharing the pot.

In other embodiment, the number of betting variations and delivery of cards to players is extensive and the size of bet variations are extensive. The game could be played without a first ante bet. Bingo50 is a game played with all cards both as hold cards and community cards are dealt up so all player may calculate their odds on a winning hand. It is conceivable to have variations of the game played with a card or cards dealt down. Bingo50 is played with players betting in no particular order, but a betting button may be implemented to make players bet in a clockwise fashion with the button rotating around the table. All of the game variations can be played in a tournament setting where thousands of players have put up a set tournament buy in and receive a specific number of chips. Players are seated at one of many tables and as ante's and bet values continuously rise, players are knocked out of the tournament till you are left with only winning players or played all the way down to one winning champion. Tournament variation can also be used for a single table scenario where eight (8) players or even two (2) players play with a set number of chips and steadily increasing ante's and bets as the time of play continues. Any 5 letters may be used to play the same game. An additional letter may be added to play the same game. Twenty-five (25) symbols and two (2) numbers could be implemented to achieve the same jackpot system.

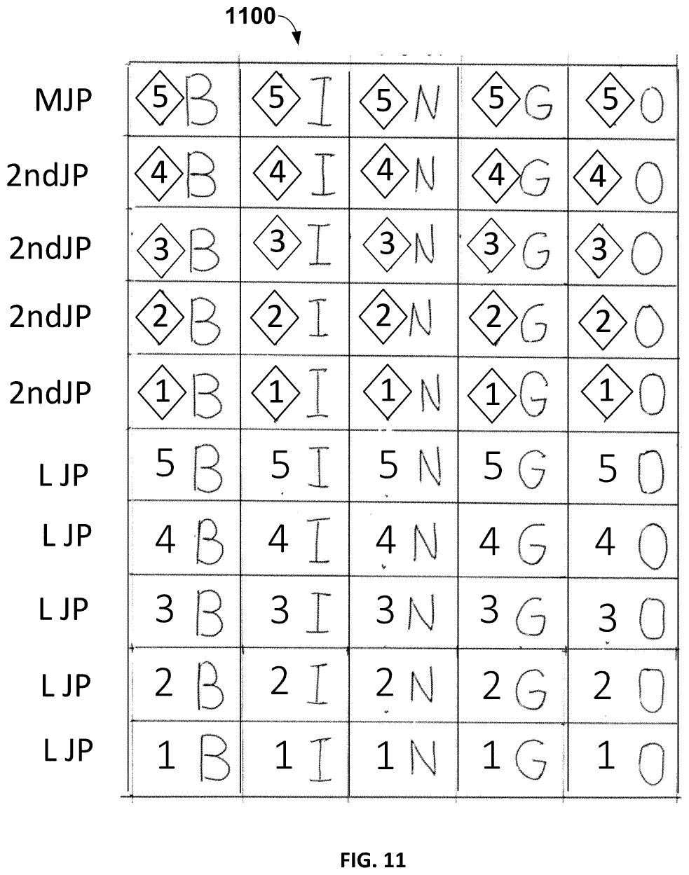

FIG. 11 is an illustration of an exemplary BINGO50 card deck and card features 1100, in accordance with an embodiment of the present invention. In one embodiment, twenty-five (25) of the playing cards in the deck have a diamond symbol on the card. The other twenty-five (25) of the playing cards have no diamond symbol on the card. Each letter in the deck has a number on the card from 1 to 5 on both the diamond cards and the non-diamond cards. Referring to FIG. 11, table 1100 shows all 50 of the cards and card features. FIG. 11 also shows a series of jackpot hands in a table. MJP is a 5-diamond bingo main jackpot, 2ndJP is the secondary jackpot all diamond same number bingo series of hands, LJP is a jackpot series of hands with no diamond characters but same number bingo. There are multiple setups for jackpot accumulations. Jackpots primarily come from player's in the hand either putting up a chip to increase the progressive jackpot or fixed jackpot, or having a portion of the total pot taken out as a percentage of the pot, for the jackpot. There can also be jackpots that are sponsored by outside interests. For example, sponsors wishing to get involved with the Bingo50 community and putting up jackpot prizes for players to win.

In some embodiment, the following describes some of the jackpot arrangements.

Five (5) diamond jackpot—each card in the player's bingo has a number 5, a diamond, and has to be both hold cards and the first 3 community cards in order to qualify.
Same number and all diamond jackpot—each card in the players bingo has matching number and diamond, has to be both hold cards and first 3 community cards.
Matching number jackpot—each card in the players bingo has the same number, has to be both hold cards and first 3 community cards.
All diamond jackpot—each card in the players bingo has a diamond symbol, has to be both hold cards and first 3 community cards.
Same letter jackpot—player achieves a 5 of the same letter using both hold cards and first 3 community cards. Special jackpots may be achieved by making the jackpot only available to a specific letter (only the 5 B jackpot, or once a B jackpot is achieved only the I, N, G, O 5 letter jackpots are available). There are multiple setups for jackpot accumulations. Jackpots primarily come from player's in the hand either putting up a chip to increase the progressive jackpot or fixed jackpot, or having a portion of the total pot taken out as a percentage of the pot, for the jackpot. There can also be jackpots that are sponsored by outside interests such as but not limited to sponsors wishing to get involved with the Bingo50 community and putting up jackpot prizes for players to win.

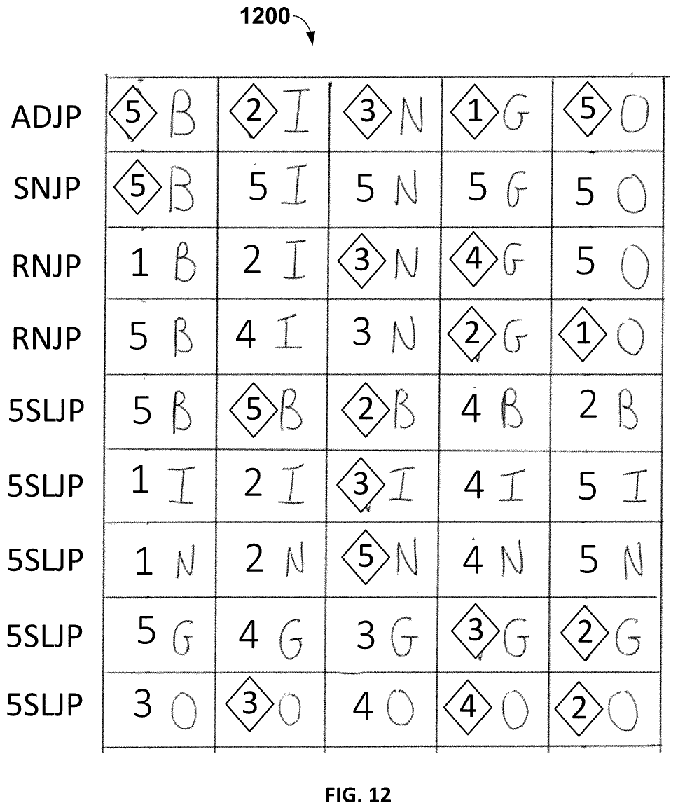

FIG. 12 is an illustration of an exemplary BINGO50 game play jackpot hands 1200, in accordance with an embodiment of the present invention. In one embodiment, FIG. 12 shows further jackpot hands 1200 in a table. ADJP is an all-diamond bingo, SNJP is a same number bingo, RNJP is a running number series of bingo's, 5SLJP is a 5 of same letter jackpot series. In further embodiments, other jackpots may be used. The illustration shows how the number and diamond markings on the cards are used for jackpot scenarios. When a player has a jackpot holding, the jackpot is a separate achievement from the accrued pot which players have bet into, even though players may have had a percentage of the pot taken out for jackpot. The dealer, in a live card setting, will acknowledge the jackpot hand and award the player the value of the achieved hand either from the dealer tray or by having a supervisor acknowledge the win and bring the value of the win to the player. The jackpot amount is a separate award and as such does not have to added to a players chip stack. In an electronic game the jackpot is awarded automatically to the winning player with no dealer involvement. In the case of extremely large jackpots management may be involved to arrange proper transfer of the jackpot.

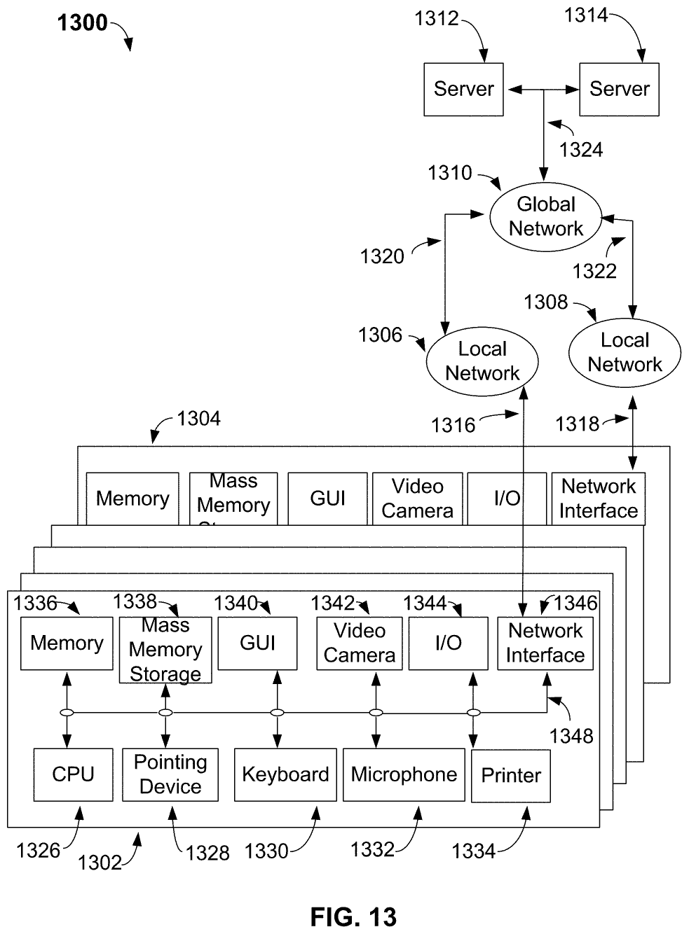

FIG. 13 is a block diagram depicting an exemplary client/server system which may be used by an exemplary web-enabled/networked BINGO50 game embodiment of the present invention.

A communication system 1300 includes a multiplicity of clients with a sampling of clients denoted as a client 1302 and a client 1304, a multiplicity of local networks with a sampling of networks denoted as a local network 1306 and a local network 1308, a global network 1310 and a multiplicity of servers with a sampling of servers denoted as a server 1312 and a server 1314.

Client 1302 may communicate bi-directionally with local network 1306 via a communication channel 1316. Client 1304 may communicate bi-directionally with local network 1308 via a communication channel 1318. Local network 1306 may communicate bi-directionally with global network 1310 via a communication channel 1320. Local network 1308 may communicate bi-directionally with global network 1310 via a communication channel 1322. Global network 1310 may communicate bi-directionally with server 1312 and server 1314 via a communication channel 1324. Server 1312 and server 1314 may communicate bi-directionally with each other via communication channel 1324. Furthermore, clients 1302, 1304, local networks 1306, 1308, global network 1310 and servers 1312, 1314 may each communicate bi-directionally with each other.

In one embodiment, global network 1310 may operate as the Internet. It will be understood by those skilled in the art that communication system 1300 may take many different forms. Non-limiting examples of forms for communication system 1300 include local area networks (LANs), wide area networks (WANs), wired telephone networks, wireless networks, or any other network supporting data communication between respective entities.

Clients 1302 and 1304 may take many different forms. Non-limiting examples of clients 1302 and 1304 include personal computers, personal digital assistants (PDAs), cellular phones and smartphones that a player may use in joining the game whether in the same location or remotely.

Client 1302 may include a CPU 1326, a pointing device 1328, a keyboard 1330, a microphone 1332, a printer 1334, a memory 1336, a mass memory storage 1338, a GUI 1340, a video camera 1342, an input/output interface 1344 and a network interface 1346.

CPU 1326, pointing device 1328, keyboard 1330, microphone 1332, printer 1334, memory 1336, mass memory storage 1338, GUI 1340, video camera 1342, input/output interface 1344 and network interface 1346 may communicate in a unidirectional manner or a bi-directional manner with each other via a communication channel 1348. Communication channel 1348 may be configured as a single communication channel or a multiplicity of communication channels.

CPU 1326 may be comprised of a single processor or multiple processors. CPU 1326 may be of various types including micro-controllers (e.g., with embedded RAM/ROM) and microprocessors such as programmable devices (e.g., RISC or SISC based, or CPLDs and FPGAs) and devices not capable of being programmed such as gate array ASICs (Application Specific Integrated Circuits) or general-purpose microprocessors.

As is well known in the art, memory 1336 is used typically to transfer data and instructions to CPU 1326 in a bi-directional manner. Memory 1336, as discussed previously, may include any suitable computer-readable media, intended for data storage, such as those described above excluding any wired or wireless transmissions unless specifically noted. Mass memory storage 1338 may also be coupled bi-directionally to CPU 1326, provides additional data storage capacity, and may include any of the computer-readable media described above. Mass memory storage 1338 may be used to store programs, data and the like and is typically a secondary storage medium such as a hard disk. It will be appreciated that the information retained within mass memory storage 1338, may, in appropriate cases, be incorporated in standard fashion as part of memory 1336 as virtual memory.

CPU 1326 may be coupled to GUI 1340. GUI 1340 enables a user to view the operation of computer operating system and software running the BINGO50 games including the variations played. CPU 1326 may be coupled to pointing device 1328. Non-limiting examples of pointing device 1328 include computer mouse, trackball, and touchpad. Pointing device 1328 enables a user with the capability to maneuver a computer cursor about the viewing area of GUI 1340 and select areas or features in the viewing area of GUI 1340. CPU 1326 may be coupled to keyboard 1330. Keyboard 1330 enables a user with the capability to input alphanumeric textual information to CPU 1326. CPU 1326 may be coupled to microphone 1332. Microphone 1332 enables audio produced by a user to be recorded, processed, and communicated by CPU 1326. CPU 1326 may be connected to printer 1334. Printer 1334 enables a user with the capability to print information to a sheet of paper. CPU 1326 may be connected to video camera 1342. Video camera 1342 enables video produced or captured by user to be recorded, processed, and communicated by CPU 1326.

CPU 1326 may also be coupled to input/output interface 1344 that connects to one or more input/output devices such as such as CD-ROM, video monitors, track balls, mice, keyboards, microphones, touch-sensitive displays, transducer card readers, magnetic or paper tape readers, tablets, styluses, voice or handwriting recognizers, or other well-known input devices such as, of course, other computers.

Finally, CPU 1326 optionally may be coupled to network interface 1346 which enables communication with an external device such as a database or a computer or telecommunications or internet network using an external connection shown generally as communication channel 1316, which may be implemented as a hardwired or wireless communications link using suitable conventional technologies. With such a connection, CPU 1326 might receive information from the network, or might output information to a network in the course of performing the method steps described in the teachings of the present invention.

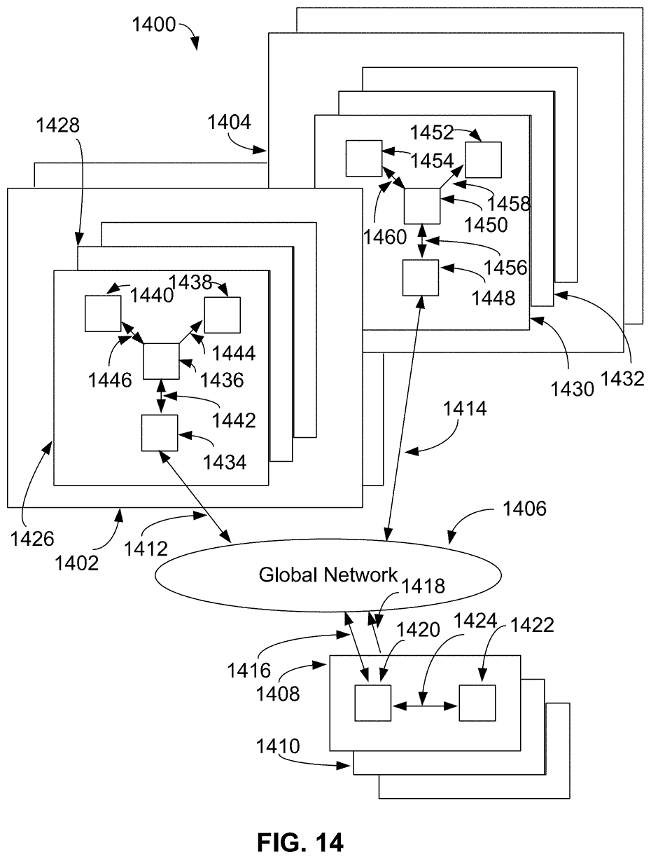

FIG. 14 illustrates a block diagram depicting a conventional client/server communication system, which may be used by an exemplary web-enabled/networked BINGO50 game embodiment of the present invention.

A communication system 1400 includes a multiplicity of networked regions with a sampling of regions denoted as a network region 1402 and a network region 1404, a global network 1406 and a multiplicity of servers with a sampling of servers denoted as a server device 1408 and a server device 1410.

Network region 1402 and network region 1404 may operate to represent a network contained within a geographical area or region. Non-limiting examples of representations for the geographical areas for the networked regions may include postal zip codes, telephone area codes, states, counties, cities, and countries. Elements within network region 1402 and 1404 may operate to communicate with external elements within other networked regions or within elements contained within the same network region.

In some implementations, global network 1406 may operate as the Internet. It will be understood by those skilled in the art that communication system 1400 may take many different forms. Non-limiting examples of forms for communication system 1400 include local area networks (LANs), wide area networks (WANs), wired telephone networks, cellular telephone networks or any other network supporting data communication between respective entities via hardwired or wireless communication networks. Global network 1406 may operate to transfer information between the various networked elements.

Server device 1408 and server device 1410 may operate to execute software instructions, store information, support database operations and communicate with other networked elements. Non-limiting examples of software and scripting languages which may be executed on server device 1408 and server device 1410 include C, C++, C#, and Java.

Network region 1402 may operate to communicate bi-directionally with global network 1406 via a communication channel 1412. Network region 1404 may operate to communicate bi-directionally with global network 1406 via a communication channel 1414. Server device 1408 may operate to communicate bi-directionally with global network 1406 via a communication channel 1416. Server device 1410 may operate to communicate bi-directionally with global network 1406 via a communication channel 1418. Network region 1402 and 1404, global network 1406 and server devices 1408 and 1410 may operate to communicate with each other and with every other networked device located within communication system 1400.

Server device 1408 includes a networking device 1420 and a server 1422. Networking device 1420 may operate to communicate bi-directionally with global network 1406 via communication channel 1416 and with server 1422 via a communication channel 1424. Server 1422 may operate to execute software instructions and store information.

Network region 1402 includes a multiplicity of clients with a sampling denoted as a client 1426 and a client 1428. Client 1426 includes a networking device 1434, a processor 1436, a GUI 1438 and an interface device 1440. Non-limiting examples of devices for GUI 1438 include monitors, televisions, cellular telephones, smartphones, and PDAs (Personal Digital Assistants). Non-limiting examples of interface device 1440 include pointing device, mouse, trackball, scanner, and printer. Networking device 1434 may communicate bi-directionally with global network 1406 via communication channel 1412 and with processor 1436 via a communication channel 1442. GUI 1438 may receive information from processor 1436 via a communication channel 1444 for presentation to a user for viewing. Interface device 1440 may operate to send control information to processor 1436 and to receive information from processor 1436 via a communication channel 1446. Network region 1404 includes a multiplicity of clients with a sampling denoted as a client 1430 and a client 1432. Client 1430 includes a networking device 1448, a processor 1450, a GUI 1452 and an interface device 1454. Non-limiting examples of devices for GUI 1438 include monitors, televisions, cellular telephones, smartphones, and PDAs (Personal Digital Assistants). Non-limiting examples of interface device 1440 include pointing devices, mousse, trackballs, scanners, and printers. Networking device 1448 may communicate bi-directionally with global network 1406 via communication channel 1414 and with processor 1450 via a communication channel 1456. GUI 1452 may receive information from processor 1450 via a communication channel 1458 for presentation to a user for viewing. Interface device 1454 may operate to send control information to processor 1450 and to receive information from processor 1450 via a communication channel 1460.

For example, consider the case where a user interfacing with client 1426 may want to execute a networked application. A user may enter the IP (Internet Protocol) address for the networked application using interface device 1440. The IP address information may be communicated to processor 1436 via communication channel 1446. Processor 1436 may then communicate the IP address information to networking device 1434 via communication channel 1442. Networking device 1434 may then communicate the IP address information to global network 1406 via communication channel 1412. Global network 1406 may then communicate the IP address information to networking device 1420 of server device 1408 via communication channel 1416. Networking device 1420 may then communicate the IP address information to server 1422 via communication channel 1424. Server 1422 may receive the IP address information and after processing the IP address information may communicate return information to networking device 1420 via communication channel 1424. Networking device 1420 may communicate the return information to global network 1406 via communication channel 1416. Global network 1406 may communicate the return information to networking device 1434 via communication channel 1412. Networking device 1434 may communicate the return information to processor 1436 via communication channel 1442. Processor 14146 may communicate the return information to GUI 14148 via communication channel 1444. User may then view the return information on GUI 1438.

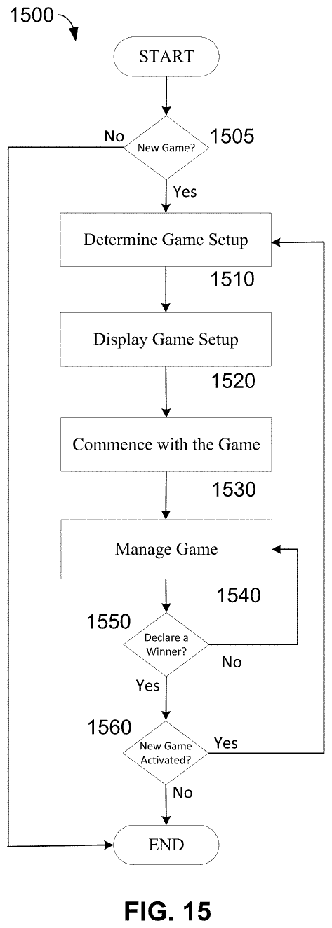

FIG. 15 illustrates a flowchart depicting a bingo50 card game system, in accordance with an embodiment of the present invention. In one embodiment, the bingo50 card game system comprises a method including steps for playing the game. For example, in a Step 1505, determine whether a new game may be started. If No, the game ends. If Yes, in a Step 1510, referring to FIGS. 1-10 and 15, determine the number of players 10 including but not limited to creating a list of all the players 10 from a sign-up sheet. Determining an amount of wagering money each player brings to the game from the amount of money each player exchange for betting chips (A)(B). Determining an amount of ante bet (A) chosen by the players 10. Determining an amount of maximum and/or minimum bet based on what the players have voted on. Determining the number of hold cards 20 to distribute to each player (e.g., P1-P4), a predetermined condition of the distributed hold cards (e.g., whether face up or face down), and the total number of community cards to deal. In a Step 1520, the game setup showing all the players 10, community cards placement 40, deck cards 50, pot 35, bet 30, etc., is displayed. For example, as shown in FIG. 1. In a Step 1530, determine which player(s) wagered the initial or ante bet (A), designate which player is active (e.g., player(s) who placed the ante bet) or inactive (e.g., player(s) that folds their hold card). Distribute hold cards 20 (e.g., two (2) cards) to each active player, determine which player(s) wagers the chip bet (B), designate which player is active (e.g., player(s) who placed the chip bet) or inactive (e.g., player(s) that folds their hold card). Deal one or more community cards 40 face up, determine which player puts up a continuity bet (B). In a Step 1540, the game is managed including determining pot amount 35, determining which player puts up a continuity bet (B), collect the continuity bet and add the continuity bet to the pot. Deal a third, fourth, and fifth community card 40 face up and collecting the continuity bet in between. Determine whose hold cards 20 in combination with the community cards 40 completes B-I-N-G-O or five (5) of the same letters. In a Step 1550, determine which player(s) 10 completes B-I-N-G-O or five (5) of the same letters. If Yes, declare the player(s) 10 whose hold cards 20 in combination with the community cards 40 completes B-I-N-G-O or five (5) of the same letters, a winner(s). Distribute the pot to the winner(s), reshuffle the deck of cards 50, etc. If None, continue dealing the community cards 40 up to five community cards while determining which player 10 is active and inactive, and the continuing bets (B) are collected until there is a winner. In a Step 1560, determine whether a new game is requested. If No, the game ends. If Yes, the process jumps to Step 1510 to start a new game.

In additional embodiment, the Bingo50 card game comprises a system and method for playing the game. The system may include a non-transitory computer-readable storage medium with an executable program stored thereon, wherein the program instructs one or more processors to perform the following steps. For example, in a Step 1505, determine whether a new game may be started. For example, but not limited to, a press of a button or a tap on a touch screen. If No, the game ends. If Yes, in a Step 1510, referring to FIGS. 1-10 and 15, determine the number of players 10 including but not limited to creating a list of all the players 10 from a sign-up sheet. Determining an amount of wagering money each player brings to the game from the amount of money each player exchange for betting chips (A)(B). Determining an amount of ante bet (A) chosen by the players 10. Determining an amount of maximum and/or minimum bet based on what the players have voted on. Determining the number of hold cards 20 to distribute to each player (e.g., Pl-P4), a predetermined condition of the distributed hold cards (e.g., whether face up or face down), and the total number of community cards to deal. In a Step 1520, the game setup showing all the players 10, community cards placement 40, deck cards 50, pot 35, bet 30, etc., is displayed. For example, as shown in FIG. 1. In a Step 1530, determine which player(s) wagered the initial or ante bet (A), designate which player is active (e.g., player(s) who placed the ante bet) or inactive (e.g., player(s) that folds their hold card). Distribute hold cards 20 (e.g., two (2) cards) to each active player, determine which player(s) wagers the chip bet (B), designate which player is active (e.g., player(s) who placed the chip bet) or inactive (e.g., player(s) that folds their hold card). Deal one or more community cards 40 face up, determine which player puts up a continuity bet (B). In a Step 1540, the game is managed including determining pot amount 35, determining which player puts up a continuity bet (B), collect the continuity bet and add the continuity bet to the pot. Deal a third, fourth, and fifth community card 40 face up and collecting the continuity bet in between. Determine whose hold cards 20 in combination with the community cards 40 completes B-I-N-G-O or five (5) of the same letters. In a Step 1550, determine which player(s) 10 completes B-I-N-G-O or five (5) of the same letters. If Yes, declare the player(s) 10 whose hold cards 20 in combination with the community cards 40 completes B-I-N-G-O or five (5) of the same letters, a winner(s). Distribute the pot to the winner(s), reshuffle the deck of cards 50, etc. If None, continue dealing the community cards 40 up to five community cards while determining which player 10 is active and inactive, and the continuing bets (B) are collected until there is a winner. In a Step 1560, determine whether a new game is requested. If No, the game ends. If Yes, the process jumps to Step 1510 to start a new game.

Those skilled in the art will readily recognize, in light of and in accordance with the teachings of the present invention, that any of the foregoing steps and/or system modules may be suitably replaced, reordered, removed and additional steps and/or system modules may be inserted depending upon the needs of the particular application, and that the systems of the foregoing embodiments may be implemented using any of a wide variety of suitable processes and system modules, and is not limited to any particular computer hardware, software, middleware, firmware, microcode and the like. For any method steps described in the present application that can be carried out on a computing machine, a typical computer system can, when appropriately configured or designed, serve as a computer system in which those aspects of the invention may be embodied. Such computers referenced and/or described in this disclosure may be any kind of computer, either general purpose, or some specific purpose computer such as, but not limited to, a workstation, a mainframe, GPU, ASIC, etc. The programs may be written in C, or Java, Brew, or any other suitable programming language. The programs may be resident on a storage medium, e.g., magnetic, or optical, e.g., without limitation, the computer hard drive, a removable disk or media such as, without limitation, a memory stick or SD media, or other removable medium. The programs may also be run over a network, for example, with a server or other machine sending signals to the local machine, which allows the local machine to carry out the operations described herein.

Those skilled in the art will readily recognize, in light of and in accordance with the teachings of the present invention, that any of the foregoing steps may be suitably replaced, reordered, removed and additional steps may be inserted depending upon the needs of the particular application. Moreover, the prescribed method steps of the foregoing embodiments may be implemented using any physical and/or hardware system that those skilled in the art will readily know is suitable in light of the foregoing teachings. For any method steps described in the present application that can be carried out on a computing machine, a typical computer system can, when appropriately configured or designed, serve as a computer system in which those aspects of the invention may be embodied. Thus, the present invention is not limited to any particular tangible means of implementation.

It will be further apparent to those skilled in the art that at least a portion of the novel method steps and/or system components of the present invention may be practiced and/or located in location(s) possibly outside the jurisdiction of the United States of America (USA), whereby it will be accordingly readily recognized that at least a subset of the novel method steps and/or system components in the foregoing embodiments must be practiced within the jurisdiction of the USA for the benefit of an entity therein or to achieve an object of the present invention. Thus, some alternate embodiments of the present invention may be configured to comprise a smaller subset of the foregoing means for and/or steps described that the applications designer will selectively decide, depending upon the practical considerations of the particular implementation, to carry out and/or locate within the jurisdiction of the USA. For example, any of the foregoing described method steps and/or system components which may be performed remotely over a network (e.g., without limitation, a remotely located server) may be performed and/or located outside of the jurisdiction of the USA while the remaining method steps and/or system components (e.g., without limitation, a locally located client) of the forgoing embodiments are typically required to be located/performed in the USA for practical considerations. In client-server architectures, a remotely located server typically generates and transmits required information to a US based client, for use according to the teachings of the present invention. Depending upon the needs of the particular application, it will be readily apparent to those skilled in the art, in light of the teachings of the present invention, which aspects of the present invention can or should be located locally and which can or should be located remotely. Thus, for any claim's construction of the following claim limitations that are construed under 35 USC § 112 (6)/(f) it is intended that the corresponding means for and/or steps for carrying out the claimed function are the ones that are locally implemented within the jurisdiction of the USA, while the remaining aspect(s) performed or located remotely outside the USA are not intended to be construed under 35 USC § 112 (6) pre-AIA or 35 USC § 112 (f) post AIA.

It is noted that according to USA law, all claims must be set forth as a coherent, cooperating set of limitations that work in functional combination to achieve a useful result as a whole. Accordingly, for any claim having functional limitations interpreted under 35 USC § 112 (6)/(f) where the embodiment in question is implemented as a client-server system with a remote server located outside of the USA, each such recited function is intended to mean the function of combining, in a logical manner, the information of that claim limitation with at least one other limitation of the claim. For example, in client-server systems where certain information claimed under 35 USC § 112 (6)/(f) is/(are) dependent on one or more remote servers located outside the USA, it is intended that each such recited function under 35 USC § 112 (6)/(f) is to be interpreted as the function of the local system receiving the remotely generated information required by a locally implemented claim limitation, wherein the structures and or steps which enable, and breath life into the expression of such functions claimed under 35 USC § 112 (6)/(f) are the corresponding steps and/or means located within the jurisdiction of the USA that receive and deliver that information to the client (e.g., without limitation, client-side processing and transmission networks in the USA). When this application is prosecuted or patented under a jurisdiction other than the USA, then “USA” in the foregoing should be replaced with the pertinent country or countries or legal organization(s) having enforceable patent infringement jurisdiction over the present patent application, and “35 USC § 112 (6)/(f)” should be replaced with the closest corresponding statute in the patent laws of such pertinent country or countries or legal organization(s).

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

It is noted that according to USA law 35 USC § 112 (1), all claims must be supported by sufficient disclosure in the present patent specification, and any material known to those skilled in the art need not be explicitly disclosed. However, 35 USC § 112 (6) requires that structures corresponding to functional limitations interpreted under 35 USC § 112 (6) must be explicitly disclosed in the patent specification. Moreover, the USPTO's Examination policy of initially treating and searching prior art under the broadest interpretation of a “mean for” or “steps for” claim limitation implies that the broadest initial search on 35 USC § 112(6) (post AIA 112(f)) functional limitation would have to be conducted to support a legally valid Examination on that USPTO policy for broadest interpretation of “mean for” claims. Accordingly, the USPTO will have discovered a multiplicity of prior art documents including disclosure of specific structures and elements which are suitable to act as corresponding structures to satisfy all functional limitations in the below claims that are interpreted under 35 USC § 112(6) (post AIA 112(f)) when such corresponding structures are not explicitly disclosed in the foregoing patent specification. Therefore, for any invention element(s)/structure(s) corresponding to functional claim limitation(s), in the below claims interpreted under 35 USC § 112(6) (post AIA 112(f)), which is/are not explicitly disclosed in the foregoing patent specification, yet do exist in the patent and/or non-patent documents found during the course of USPTO searching, Applicant(s) incorporate all such functionally corresponding structures and related enabling material herein by reference for the purpose of providing explicit structures that implement the functional means claimed. Applicant(s) request(s) that fact finders during any claim's construction proceedings and/or examination of patent allowability properly identify and incorporate only the portions of each of these documents discovered during the broadest interpretation search of 35 USC § 112(6) (post AIA 112(f)) limitation, which exist in at least one of the patents and/or non-patent documents found during the course of normal USPTO searching and or supplied to the USPTO during prosecution. Applicant(s) also incorporate by reference the bibliographic citation information to identify all such documents comprising functionally corresponding structures and related enabling material as listed in any PTO Form-892 or likewise any information disclosure statements (IDS) entered into the present patent application by the USPTO or Applicant(s) or any 3^{rd} parties. Applicant(s) also reserve its right to later amend the present application to explicitly include citations to such documents and/or explicitly include the functionally corresponding structures which were incorporate by reference above.

Thus, for any invention element(s)/structure(s) corresponding to functional claim limitation(s), in the below claims, that are interpreted under 35 USC § 112(6) (post AIA 112(f)), which is/are not explicitly disclosed in the foregoing patent specification, Applicant(s) have explicitly prescribed which documents and material to include the otherwise missing disclosure, and have prescribed exactly which portions of such patent and/or non-patent documents should be incorporated by such reference for the purpose of satisfying the disclosure requirements of 35 USC § 112 (6). Applicant(s) note that all the identified documents above which are incorporated by reference to satisfy 35 USC § 112 (6) necessarily have a filing and/or publication date prior to that of the instant application, and thus are valid prior documents to incorporated by reference in the instant application.

Having fully described at least one embodiment of the present invention, other equivalent or alternative methods of implementing according to the present invention will be apparent to those skilled in the art. Various aspects of the invention have been described above by way of illustration, and the specific embodiments disclosed are not intended to limit the invention to the particular forms disclosed. The particular implementation of the system and method for playing wagering bingo50 card game may vary depending upon the particular context or application. By way of example, and not limitation, the system and method for playing wagering bingo50 card game described in the foregoing were principally directed to bingo card game implementations; however, similar techniques may instead be applied to poker games, which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

The corresponding structures, materials, acts, and equivalents of all means or step plus function elements in the claims below are intended to include any structure, material, or act for performing the function in combination with other claimed elements as specifically claimed.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The Abstract is provided to comply with 37 C.F.R. Section 1.72(b) requiring an abstract that will allow the reader to ascertain the nature and gist of the technical disclosure. That is, the Abstract is provided merely to introduce certain concepts and not to identify any key or essential features of the claimed subject matter. It is submitted with the understanding that it will not be used to limit or interpret the scope or meaning of the claims.

The following claims are hereby incorporated into the detailed description, with each claim standing on its own as a separate embodiment.

Only those claims which employ the words “means for” or “steps for” are to be interpreted under 35 USC 112, sixth paragraph (pre-AIA) or 35 USC 112(f) post-AIA. Otherwise, no limitations from the specification are to be read into any claims, unless those limitations are expressly included in the claims.

What is claimed is:

1. A system comprising:
a deck of cards that is configured to play a bingo game, in which said deck of cards comprise 50 individual cards;
in which said 50 individual cards include:
at least 10 cards with letter B's;
at least 10 cards with letter I's;
at least 10 cards with letter N's;
at least 10 cards with letter G's; and
at least 10 cards with letter O's;
a set of game play instructions, wherein said set of game play instructions include rules for playing said bingo game;
wherein said set of game play instructions comprise a set of instructions on how to play the game; and
wherein winning a hand in said bingo game comprise making at least one of a bingo and five of the same letter from any combination of hold cards and community cards.

2. The system of claim 1, in which said making a bingo comprise completing the word B-I-N-G-O from any combination of said hold cards and community cards.

3. The system of claim 2, in which said making five of the same letter comprises completing at least one of, 5 letter B's, 5 letter I's, 5 letter N's, 5 letter G's, 5 letter O's.

4. The system of claim 3, in which said hold cards comprise at least two or more cards.

5. The system of claim 4, in which said community cards comprise at least a total of five or more cards.

6. The system of claim 5, in which said winning cards comprise five cards chosen from any combination of said hold cards and community cards.

7. The system of claim 2, in which said set of game play instructions comprise a jackpot arrangement including five (5) diamond jackpot where each card in the player's bingo has a number 5, a diamond, and both hold cards in combination with 3 community cards in order to qualify.

8. The system of claim 7, in which said set of game play instructions further comprise a jackpot arrangement including same number and all diamond jackpot where each card in the players bingo has matching number and diamond, include both hold cards and first 3 community cards.

9. The system of claim 8, in which said set of game play instructions further comprise a jackpot arrangement including matching number jackpot where each card in the players bingo has the same number, include both hold cards and first 3 community cards.

10. The system of claim 9, in which said set of game play instructions further comprise a jackpot arrangement including all diamond jackpot where each card in the players bingo has a diamond symbol, include both hold cards and first 3 community cards.

11. The system of claim 10, in which said set of game play instructions further comprise a jackpot arrangement including same letter jackpot where a 5 of the same letter is completed using both hold cards and first 3 community cards.

12. The system of claim 3, in which said bingo game comprise a BINGO50-STEADY game play.

13. The system of claim 3, in which said bingo game comprise a BINGO50-FREEZE game play.

14. The system of claim 3, in which said bingo game comprise a BINGO50-MAX game play.

15. The system of claim 3, in which said set of game play instructions further comprise a continuation betting process where all cards are dealt face up.

16. The system of claim 3, in which said set of game play instructions further comprise the steps of:
placing an ante bet prior to receiving two hold cards dealt face up;
placing a bet to continue with the pot or fold the hold cards;
dealing a first community card face up; and
dealing additional community cards face up until at least one of a bingo and five of the same letter is completed.

17. A system comprising:
a non-transitory computer-readable storage medium with an executable program stored thereon, wherein the program instructs one or more processors to perform the following steps:
determining whether a new bingo game is to be started;
presenting a game setup showing all the players, a community cards placement, a deck of cards, a pot;
collecting ante bets and adding said ante bets to said pot;
distribute hold cards;
collecting bets and adding said bets to said pot;
dealing a community card;
collecting continuing bets and adding said continuing bets to said pot;
dealing additional community cards and collecting continuing bets and adding said continuing bets to said pot until at least one of a bingo and five of the same letter is completed.

18. The system of claim 17, in which said deck of cards comprise 50 individual cards.

19. The system of claim 18, in which said 50 individual cards include:
at least 10 cards with letter B's;
at least 10 cards with letter I's;
at least 10 cards with letter N's;
at least 10 cards with letter G's; and
at least 10 cards with letter O's.

20. A system comprising:
a deck of cards that is configured to play a bingo game, in which said deck of cards comprise 50 individual cards;
in which said 50 individual cards include:
at least 10 cards with letter B's;
at least 10 cards with letter I's;
at least 10 cards with letter N's;
at least 10 cards with letter G's; and
at least 10 cards with letter O's;
a non-transitory computer-readable storage medium with an executable program stored thereon, wherein the program instructs one or more processors to perform the following steps:
presenting a game setup showing all the players, a community cards placement, said deck of cards, a pot;
collecting ante bets and adding said ante bets to said pot;
distribute hold cards from said deck of cards;
collecting bets and adding said bets to said pot;
dealing a community card from said deck of cards;
collecting continuing bets and adding said continuing bets to said pot;
dealing additional community cards and collecting continuing bets and adding said continuing bets to said pot until at least one of a bingo and five of the same letter is completed.
